(19) United States
(12) Patent Application Publication
(10) Pub. No.: US 2021/0150411 A1
(43) Pub. Date: May 20, 2021

(54) SECURE ARTIFICIAL INTELLIGENCE MODEL TRAINING AND REGISTRATION SYSTEM

(71) Applicant: Equinix, Inc., Redwood City, CA (US)

(72) Inventors: Guido Franciscus Wilhelmus Coenders, Amsterdam (NL); Kaladhar Voruganti, San Jose, CA (US); Vijaay Doraiswamy, Fremont, CA (US); Purvish Purohit, Sunnyvale, CA (US); Mahendra Malviya, San Jose, CA (US)

(21) Appl. No.: 17/097,755

(22) Filed: Nov. 13, 2020

Related U.S. Application Data
(60) Provisional application No. 62/936,023, filed on Nov. 15, 2019.

(51) Int. Cl. G06N 20/00; G06K 9/62; G06F 21/53; G06F 21/64; G06F 21/62

(52) U.S. Cl. CPC G06N 20/00; G06K 9/6256; G06F 21/6209; G06F 21/53; G06F 21/64; G06K 9/6262

(57) ABSTRACT

In general, this disclosure describes a system for securely training artificial intelligence (AI) models. The system may include communication circuitry for receiving from providers data sets, machine learning algorithms, and AI models. The data sets, machine learning algorithms, and AI models may be placed in a secure sandbox for access by a user. The user may securely train the AI models using the data sets in the secure sandbox. The secure sandbox may record AI model metadata associated with transactions involving the AI models and send the AI model metadata to a model registry. The model registry may attest to the lineage of the AI models.

This application claims the benefit of U.S. Provisional Application No. 62/936,023 filed Nov. 15, 2019; the entire contents of which is incorporated herein by reference.

### TECHNICAL FIELD

The disclosure relates to computer networks and, more specifically, to a secure artificial intelligence model training and registration system.

### BACKGROUND

Cloud computing refers to the use of dynamically scalable computing resources accessible via a network, such as the Internet. The computing resources, often referred to as a “cloud,” provide one or more services to users. These services may be categorized according to service types, which may include for examples, applications/software, platforms, infrastructure, virtualization, and servers and data storage. The names of service types are often prepended to the phrase “as-a-Service” such that the delivery of applications/software and infrastructure, as examples, may be referred to as Software-as-a-Service (SaaS), Platform-as-a-Service (PaaS), and Infrastructure-as-a-Service (IaaS), respectively.

The term “cloud-based services” or, more simply, “cloud services” refers not only to services provided by a cloud, but also to a form of service provisioning in which cloud customers contract with cloud service providers for the online delivery of services provided by the cloud. Cloud service providers manage a public, private, or hybrid cloud to facilitate the online delivery of cloud services to one or more cloud customers.

Artificial intelligence (AI) is an area of computer science focused on computer systems that are able to perform tasks normally requiring human thought. Various machine learning computer algorithms exist for processing training data sets to train AI models made up of parameters that determine an operation of an AI algorithm in inference mode. The AI model may be further refined or customized by further training on different training data sets.

### SUMMARY

In general, this disclosure describes a neutral artificial intelligence (AI) exchange system for securely creating, training, tracking, and offering AI models in a secure environment. The exchange system may be a private or independent system available to members of a consortium seeking access to AI algorithms or data of others to develop better AI models or to utilize AI models developed by others. The exchange system may provide members of the consortium, such as data scientists, with a secure environment for creating and training AI models in a secure manner that enables future prospective users of a trained AI model to verify the provenance and characteristics of the trained AI model, e.g., without such prospective users having to train the AI models themselves. In some instances, the exchange system may also permit members of the consortium to import existing AI models. The exchange system may track and securely store information, such as AI metadata, relating to the creation, training or importation of the AI models therein. For example, the exchange system may track and store information relating to where an AI model was built, who built the AI model, the data source(s) used to train the AI model, among other information. The exchange system may create a hash of the AI model and may package the hash, the AI model, and the AI metadata in a container. The hash may be used by a member of the consortium to verify and attest to the lineage or provenance of the particular AI model included in the container. If the AI model is further trained, the exchange system may continue to track and securely store AI metadata relating to the further training. The exchange system may create a new hash and package the new hash, the further trained AI model and updated AI metadata in a new container. The exchange system may make available to members of the consortium a library of containers of AI models created, trained or imported in the exchange system.

The techniques of this disclosure provide one or more technical advantages that can realize at least one practical application. For example, by tracking and storing AI metadata related to the creation, training and importation of AI models, the exchange system permits a user to make an informed decision on which AI model registered in the exchange system would provide better results. For example, if a user wanted to use an AI model to predict traffic patterns in an urban environment, an AI model trained on traffic data in a rural environment may not be as useful as an AI model trained on traffic data in another urban environment. By identifying the data used to train the AI model, the system may provide the user with important information enabling the user to select a better AI model for their purposes. In another example, a user may prefer to use an AI model built by a company or individual with a track record of creating useful AI models rather than an unknown company or individual or one that was imported and whose pedigree is unknown. Thus, by identifying the builder of the AI model, the system may assist the user in selecting a preferred AI model. Additionally, by packaging the hash, the AI model and the AI metadata in a container, the exchange system may validate the AI model for prospective users by confirming that the AI model is trained as the AI metadata indicates.

In one example, a system comprises memory; and processing circuitry coupled to the memory, the processing circuitry being operable to: build, based on input from a user, an artificial intelligence (AI) model; train, based on input from the user, the AI model; create first AI model metadata based on first transactions associated with building and training the trained AI model; compute a first hash based at least in part on the trained AI model; package the trained AI model, the first AI model metadata, and the first hash in a first container; register the first container; provide, to the user, secure access to the first container; and validate, for the user, the trained AI model based on the first hash.

In one example, a system comprises communication circuitry operable to receive data sets, machine learning algorithms and AI models from providers, a secure sandbox coupled to the communication circuitry, the secure sandbox operable to train AI models and record AI model metadata associated with training AI models, and memory operable to store the data sets, machine learning algorithms, AI models and AI model metadata.

In one example, a method comprises building, by a system and based on input from a user, an AI model; training, by the system and based on input from the user, the AI model; creating, by the system, first AI model metadata based on first transactions associated with building and training the trained AI model; computing, by the system, a first hash based at least in part on the trained AI model; package the trained AI model, the first AI model metadata, and the first hash in a first container; registering, by the system, the first container; providing, by the system to the user, secure access to the first container; and validating, by the system for the user, the trained AI model based on the first hash.

In one example, a method comprises receiving, by a system, data sets, machine learning algorithms and AI models from providers; training, by the system and based on at least one data set of the data sets, at least one AI model of the AI models; recording, by the system, AI model metadata associated with training the at least one AI model; and storing, by the system, the data sets, the machine learning algorithms, the AI modes and the AI model metadata.

In one example, a non-transitory computer-readable medium has stored thereon instructions that, when executed, cause one or more processors to: build, based on input from a user, an AI model; train, based on input from the user, the AI model; create first AI model metadata based on first transactions associated with building and training the trained AI model; compute a first hash based at least in part on the trained AI model; package the trained AI model, the first AI model metadata, and the first hash in a first container; register the first container; provide, to the user, secure access to the first container; and validate, for the user, the trained AI model based on the first hash.

In one example, a non-transitory computer-readable medium has stored thereon instructions that, when executed, cause one or more processors to receive data sets, machine learning algorithms and AI models from providers, train at least one AI model of the AI models based on at least one data set of the data sets, record AI model metadata associated with training the at least one AI model, and store the data sets, the machine learning algorithms, the AI modes and the AI model metadata.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram that illustrates a conceptual view of a network system having a metro-based cloud exchange that provides multiple cloud exchange points according to techniques described herein.

FIG. 2 is a block diagram illustrating a high-level view of a data center that provides an operating environment for a cloud-based services exchange, according to techniques described herein.

FIGS. 3A-3B are block diagrams illustrating example network infrastructure and service provisioning by a programmable network platform for a cloud exchange that aggregates the cloud services of multiple cloud service providers for provisioning to customers of the cloud exchange provider and aggregates access for multiple customers to one or more cloud service providers, in accordance with techniques described in this disclosure.

FIG. 4 is a block diagram illustrating further details of one example of a computing system that operates in accordance with one or more techniques of the present disclosure.

FIG. 5 is a block diagram illustrating an example exchange system according to techniques of the present disclosure.

FIG. 6 is a block diagram depicting an example pipeline update process according to techniques of this disclosure.

FIG. 7 is a block diagram illustrating an example AI model container according to the techniques of this disclosure.

FIG. 8 is a block diagram illustrating security aspects of the secure sandbox according to the techniques of the present disclosure.

FIG. 9 is a conceptual diagram of an example model registry update and an example model usage process according to techniques of this disclosure.

FIG. 10 is a block diagram of an example model registry according to techniques of this disclosure.

FIG. 11 is a conceptual diagram illustrating a functional overview of an example system according to techniques of the present disclosure.

FIG. 12 is a conceptual diagram illustrating a control flow of an example system according to techniques of this disclosure.

FIG. 13 is a block diagram illustrating an architecture of an example system in accordance with techniques of this disclosure.

FIG. 14 is a flowchart illustrating example AI exchange techniques according to this disclosure.

FIG. 15 is a flowchart illustrating example secure sandbox techniques according to this disclosure.

Like reference characters denote like elements throughout the figures and text.

### DETAILED DESCRIPTION

The usefulness of AI models, which may be available to a user, may be difficult for the user to evaluate. For example, the AI model may have been trained on data sets which are unknown to the user. The creator of the AI model may also be unknown to the user. As such, it may be difficult for a user to select the appropriate AI model for their purposes. Using an inappropriate AI model may lead to unsatisfactory results.

The present disclosure describes a system and method for securely exchanging data sets, machine learning algorithms and AI models. AI model metadata associated with transactions involving the AI models may be recorded. The AI model metadata may be provided to a model registry. The model registry may be used to attest to the lineage of the AI models within the exchange system. The techniques of this disclosure may provide a user with information that may be helpful in selecting an appropriate AI model.

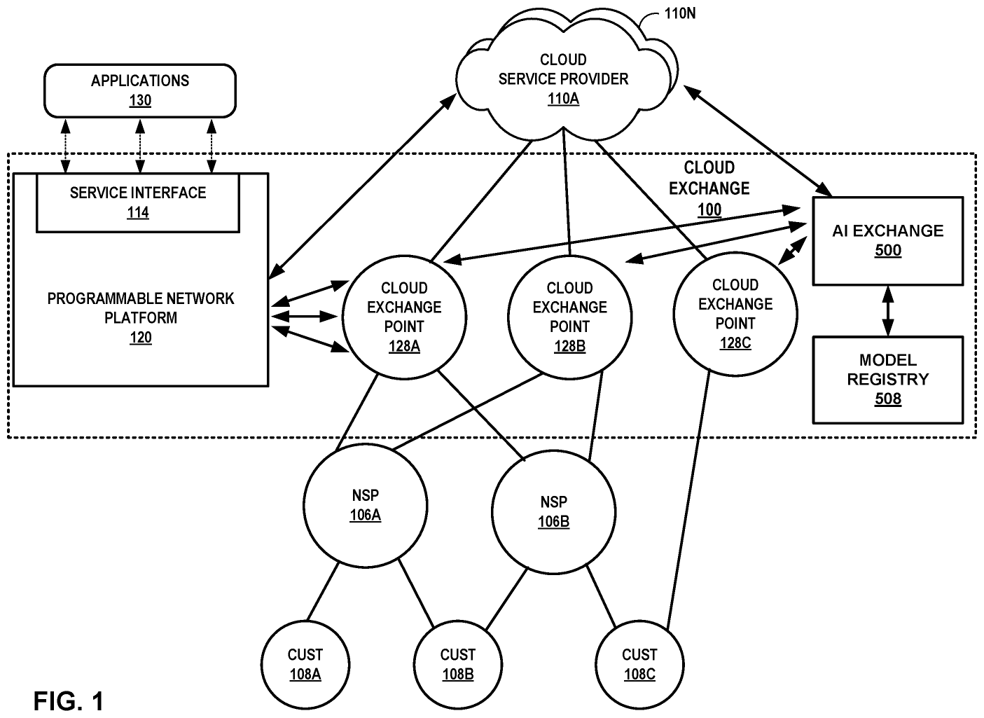

FIG. 1 illustrates a conceptual view of a network system having a metro-based cloud exchange that provides multiple cloud exchange points according to techniques described herein. Each of cloud-based services exchange points 128A-128C (described hereinafter as “cloud exchange points” and collectively referred to as “cloud exchange points 128”) of cloud-based services exchange 100 (“cloud exchange 100”) may represent a different data center geographically located within the same metropolitan area (“metro-based,” e.g., in New York City, N.Y; Silicon Valley, Calif.; Seattle-Tacoma, Wash.; Minneapolis-St. Paul, Minn.; London, UK; etc.) to provide a resilient and independent cloud-based services exchange by which cloud-based services customers (“cloud customers”) and cloud-based service providers (“cloud providers”) connect to receive and provide, respectively, cloud services. In various examples, cloud exchange 100 may include more or fewer cloud exchange points 128. In some instances, a cloud exchange 100 includes just one cloud exchange point 128. As used herein, reference to a “cloud exchange” or “cloud-based services exchange” may refer to a cloud exchange point. A cloud exchange provider may deploy instances of cloud exchanges 100 in multiple different metropolitan areas, each instance of cloud exchange 100 having one or more cloud exchange points 128.

Each of cloud exchange points 128 includes network infrastructure and an operating environment by which cloud customers 108A-108C (collectively, “cloud customers 108”) receive cloud services from multiple cloud service providers 110A-110N (collectively, “cloud service providers 110”). Cloud exchange 100 provides customers of the exchange, e.g., enterprises, network carriers, network service providers, and SaaS customers, with secure, private, virtual connections to multiple cloud service providers globally. The multiple cloud service providers participate in the cloud exchange by virtue of their having at least one accessible port in the cloud exchange by which a customer can connect to the one or more cloud services offered by the cloud service providers, respectively. Cloud exchange 100 allows private networks of any customer to be directly cross-connected to any other customer at a common point, thereby allowing direct exchange of network traffic between the networks of the customers.

Cloud customers 108 may receive cloud-based services directly via a layer 3 peering and physical connection to one of cloud exchange points 128 or indirectly via one of network service providers 106A-106B (collectively, “NSPs 106,” or alternatively, “carriers 106”). NSPs 106 provide “cloud transit” by maintaining a physical presence within one or more of cloud exchange points 128 or aggregating layer 3 access from one or customers 108. NSPs 106 may peer, at layer 3, directly with one or more cloud exchange points 128 and in so doing offer indirect layer 3 connectivity and peering to one or more customers 108 by which customers 108 may obtain cloud services from the cloud exchange 100. Each of cloud exchange points 128, in the example of FIG. 1, is assigned a different autonomous system number (ASN). For example, cloud exchange point 128A is assigned ASN 1, cloud exchange point 128B is assigned ASN 2, and so forth. Each cloud exchange point 128 is thus a next hop in a vector routing protocol (e.g., BGP) path from cloud service providers 110 to customers 108. As a result, each cloud exchange point 128 may, despite not being a transit network having one or more wide area network links and concomitant Internet access and transit policies, peer with multiple different autonomous systems via external BGP (eBGP) or other exterior gateway routing protocol in order to exchange, aggregate, and route service traffic from one or more cloud service providers 110 to customers. In other words, cloud exchange points 128 may internalize the eBGP peering relationships that cloud service providers 110 and customers 108 would maintain on a pair-wise basis. Instead, a customer 108 may configure a single eBGP peering relationship with a cloud exchange point 128 and receive, via the cloud exchange, multiple cloud services from one or more cloud service providers 110. While described herein primarily with respect to eBGP or other layer 3 routing protocol peering between cloud exchange points and customer, NSP, or cloud service provider networks, the cloud exchange points may learn routes from these networks in other ways, such as by static configuration, or via Routing Information Protocol (RIP), Open Shortest Path First (OSPF), Intermediate System-to-Intermediate System (IS-IS), or other route distribution protocol.

As examples of the above, customer 108C is illustrated as having contracted with a cloud exchange provider for cloud exchange 100 to directly access layer 3 cloud services via cloud exchange points 128C. In this way, customer 108C receives redundant layer 3 connectivity to cloud service provider 110A, for instance. Customer 108B is illustrated as having contracted with multiple NSPs 106A, 106B to have redundant cloud access to cloud exchange points 128A, 128B via respective transit networks of the NSPs 106A, 106B. The contracts described above are instantiated in network infrastructure of the cloud exchange points 128 by L3 peering configurations within switching devices of NSPs 106 and cloud exchange points 128 and L3 connections, e.g., layer 3 virtual circuits, established within cloud exchange points 128 to interconnect cloud service provider 110 networks to NSPs 106 networks and customer 108 networks, all having at least one port offering connectivity within one or more of the cloud exchange points 128.

In some examples, cloud exchange 100 allows a corresponding one of customer customers 108A, 108B of any network service providers (NSPs) or “carriers” 106A-106B (collectively, “carriers 106”) or other cloud customers including customers 108C to be directly connected, via a virtual layer 2 (L2) or layer 3 (L3) connection to any other customer network and/or to any of cloud service providers 110, thereby allowing direct exchange of network traffic among the customer networks and cloud service providers 110. The virtual L2 or L3 connection may be referred to as a “virtual circuit.”

Carriers 106 may each represent a network service provider that is associated with a transit network by which network subscribers of the carrier 106 may access cloud services offered by cloud service providers 110 via the cloud exchange 100. In general, customers of cloud service providers 110 may include network carriers, large enterprises, managed service providers (MSPs), as well as Software-as-a-Service (SaaS), Platform-aaS (PaaS), Infrastructure-aaS (IaaS), Virtualization-aaS (VaaS), and data Storage-aaS (dSaaS) customers for such cloud-based services as are offered by the cloud service providers 110 via the cloud exchange 100.

In this way, cloud exchange 100 streamlines and simplifies the process of partnering cloud service providers 110 and customers (via carriers 106 or directly) in a transparent and neutral manner. One example application of cloud exchange 100 is a co-location and interconnection data center in which cloud service providers 110 and carriers 106 and/or customers 108 may already have network presence, such as by having one or more accessible ports available for interconnection within the data center, which may represent any of cloud exchange points 128. This allows the participating carriers, customers, and cloud service providers to have a wide range of interconnectivity options within the same facility. A carrier/customer may in this way have options to create many-to-many interconnections with only a one-time hook up to one or more cloud exchange points 128. In other words, instead of having to establish separate connections across transit networks to access different cloud service providers or different cloud services of one or more cloud service providers, cloud exchange 100 allows customers to interconnect to multiple cloud service providers and cloud services.

Cloud exchange 100 may include an AI exchange 500 for enabling the secure exchange of data sets, machine learning applications, and AI models between data set, machine learning algorithm and AI model providers, such as cloud service providers 110A-N, and consumers, such as customers 108A-108C. AI exchange 500 may also enable the secure building, training and importation of AI models by data set, machine learning algorithm and AI model providers, such as cloud service providers 110A-N, and consumers, such as customers 108A-108C. Cloud exchange 100 may also include a model registry 508. Although show as being directly coupled to AI exchange 500, model registry 508 may be coupled indirectly to AI exchange 500. For example, model registry 508 may be coupled to AI exchange 500 through cloud exchange point 128C. Model registry 508 may register AI models built, trained or imported into AI exchange 500 and enable attestation of AI models' lineages as will be discussed in detail below. In the example where an AI model is imported into AI exchange 500, model registry 508 may only enable attestation of enhancements, such as training, that occur within AI exchange 500. In some examples, model registry 508 may be located in a different cloud exchange than AI exchange 500.

AI exchange 500 and model registry 508 may represent an application(s) executing within one or more data centers of the cloud exchange 100 or alternatively, off-site at a back office or branch of a cloud provider, enterprise, consortium, or other computing infrastructure (for instance). AI exchange 500 and model registry 508 may be distributed in whole or in part among the data centers, each data center associated with a different cloud exchange point 128 to make up the cloud exchange 100. Although shown as residing in a single cloud exchange 100, AI exchange 500 and model registry 508 may reside across a plurality of cloud exchanges.

Cloud exchange 100 may also include a programmable network platform 120 for dynamically programming cloud exchange 100 to responsively and assuredly fulfill service requests that encapsulate business requirements for services provided by cloud exchange 100 and/or cloud service providers 110 coupled to the cloud exchange 100. The programmable network platform 120 may, as a result, orchestrate a business-level service across heterogeneous cloud service providers 110 according to well-defined service policies, quality of service policies, service level agreements, and costs, and further according to a service topology for the business-level service.

The programmable network platform 120 enables the cloud service provider that administers the cloud exchange 100 to dynamically configure and manage the cloud exchange 100 to, for instance, facilitate virtual connections for cloud-based services delivery from multiple cloud service providers 110 to one or more cloud customers 108. The cloud exchange 100 may enable cloud customers 108 to bypass the public Internet to directly connect to cloud services providers 110 so as to improve performance, reduce costs, increase the security and privacy of the connections, and leverage cloud computing for additional applications. In this way, enterprises, network carriers, and SaaS customers, for instance, can at least in some aspects integrate cloud services with their internal applications as if such services are part of or otherwise directly coupled to their own data center network.

In other examples, programmable network platform 120 enables the cloud service provider to configure cloud exchange 100 with a L3 instance requested by a cloud customer 108, as described herein. A customer 108 may request an L3 instance to link multiple cloud service providers by the L3 instance, for example (e.g., for transferring the customer's data between two cloud service providers, or for obtaining a mesh of services from multiple cloud service providers). In some examples, programmable network platform 120 may implement AI exchange 500, model registry 508 or both.

Programmable network platform 120 may represent an application executing within one or more data centers of the cloud exchange 100 or alternatively, off-site at a back office or branch of the cloud service provider (for instance). Programmable network platform 120 may be distributed in whole or in part among the data centers, each data center associated with a different cloud exchange point 128 to make up the cloud exchange 100. Although shown as administering a single cloud exchange 100, programmable network platform 120 may control service provisioning for multiple different cloud exchanges. Alternatively or additionally, multiple separate instances of the programmable network platform 120 may control service provisioning for respective multiple different cloud exchanges.

In the illustrated example, programmable network platform 120 includes a service interface (or “service API”) 114 that defines the methods, fields, and/or other software primitives by which applications 130, such as a customer portal, may invoke the programmable network platform 120. The service interface 114 may allow carriers 106, customers 108, cloud service providers 110, and/or the cloud exchange provider programmable access to capabilities and assets of the cloud exchange 100 according to techniques described herein.

For example, the service interface 114 may facilitate machine-to-machine communication to enable dynamic provisioning of virtual circuits in the cloud exchange for interconnecting customer and/or cloud service provider networks. In this way, the programmable network platform 120 enables the automation of aspects of cloud services provisioning. For example, the service interface 114 may provide an automated and seamless way for customers to establish, de-install and manage interconnections among multiple, different cloud providers participating in the cloud exchange.

Further example details of a cloud-based services exchange can be found in U.S. patent application Ser. No. 15/099,407, filed Apr. 14, 2016 and entitled “CLOUD-BASED SERVICES EXCHANGE;” U.S. patent application Ser. No. 14/927,451, filed Oct. 29, 2015 and entitled “INTERCONNECTION PLATFORM FOR REAL-TIME CONFIGURATION AND MANAGEMENT OF A CLOUD-BASED SERVICES EXCHANGE;” and U.S. patent application Ser. No. 14/927,306, filed Oct. 29, 2015 and entitled “ORCHESTRATION ENGINE FOR REAL-TIME CONFIGURATION AND MANAGEMENT OF INTERCONNECTIONS WITHIN A CLOUD-BASED SERVICES EXCHANGE;” each of which are incorporated herein by reference in their respective entireties.

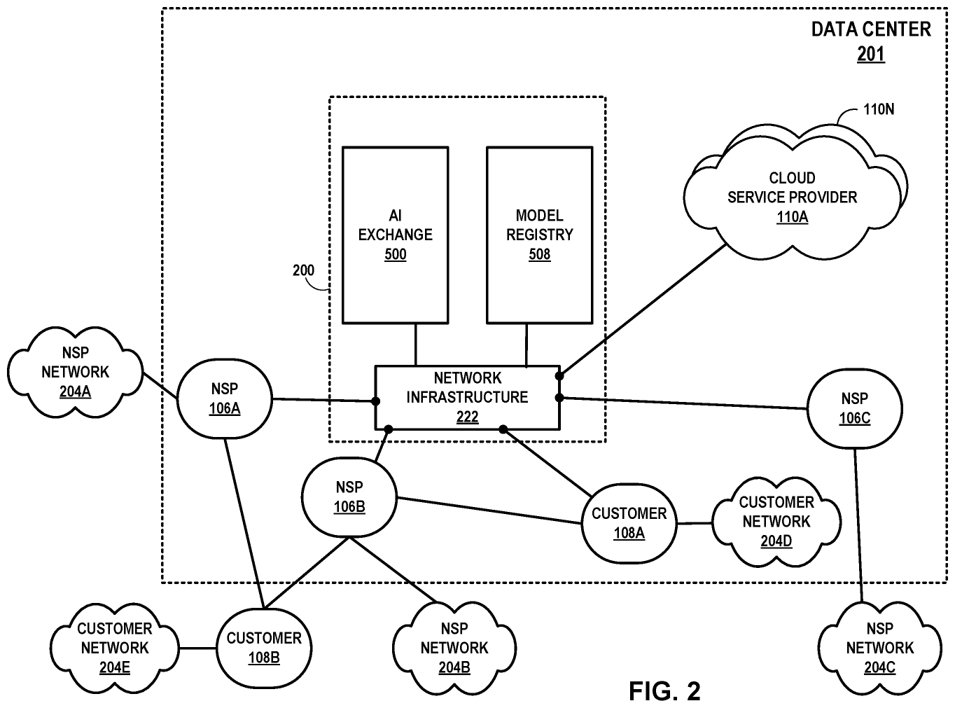

FIG. 2 is a block diagram illustrating a high-level view of a data center 201 that provides an operating environment for a cloud-based services exchange 200, according to techniques described herein. Cloud-based services exchange 200 (“cloud exchange 200”) allows a corresponding one of customer networks 204D, 204E and NSP networks 204A-204C (collectively, “‘private’ or ‘carrier’ networks 204”) of any NSPs 106A-106C or other cloud customers including customers 108A, 108B to be directly connected, via a layer 3 (L3) or layer 2 (L2) connection to any other customer network and/or to any of cloud service providers 110A-110N, thereby allowing exchange of cloud service traffic among the customer networks and/or cloud service providers 110. Data center 201 may be entirely located within a centralized area, such as a warehouse or localized data center complex, and provide power, cabling, security, and other services to NSPs, customers, and cloud service providers that locate their respective networks within the data center 201 (e.g., for co-location) and/or connect to the data center 201 by one or more external links.

Network service providers 106 may each represent a network service provider that is associated with a transit network by which network subscribers of the NSP 106 may access cloud services offered by cloud service providers 110 via the cloud exchange 200. In general, customers of cloud service providers 110 may include network carriers, large enterprises, managed service providers (MSPs), as well as Software-as-a-Service (SaaS), Platform-aaS (PaaS), Infrastructure-aaS (IaaS), Virtualization-aaS (VaaS), and data Storage-aaS (dSaaS) customers for such cloud-based services as are offered by the cloud service providers 110 via the cloud exchange 200.

In this way, cloud exchange 200 streamlines and simplifies the process of partnering cloud service providers 110 and customers 108 (indirectly via NSPs 106 or directly) in a transparent and neutral manner. One example application of cloud exchange 200 is a co-location and interconnection data center in which cloud service providers 110, NSPs 106 and/or customers 108 may already have network presence, such as by having one or more accessible ports available for interconnection within the data center. This allows the participating carriers, customers, and cloud service providers to have a wide range of interconnectivity options in the same facility.

Cloud exchange 200 of data center 201 includes network infrastructure 222 that provides a L2/L3 switching fabric by which cloud service providers 110 and customers and/or NSPs interconnect. This enables a customer and/or NSP to have options to create many-to-many interconnections with only a one-time hook up to the switching network and underlying network infrastructure 222 that presents an interconnection platform for cloud exchange 200. In other words, instead of having to establish separate connections across transit networks to access different cloud service providers or different cloud services of one or more cloud service providers, cloud exchange 200 allows customers to interconnect to multiple cloud service providers and cloud services using network infrastructure 222 within data center 201, which may represent any of the edge networks described in this disclosure, at least in part.

By using cloud exchange 200, customers can purchase services and reach out to many end users in many different geographical areas without incurring the same expenses typically associated with installing and maintaining multiple virtual connections with multiple cloud service providers 110. For example, NSP 106A can expand services using network 204B of NSP 106B. By connecting to cloud exchange 200, NSP 106 may be able to generate additional revenue by offering to sell network services to the other carriers. For example, NSP 106C can offer the opportunity to use NSP network 204C to the other NSPs.

Cloud exchange 200 may include AI exchange 500 and model registry 508. In this example, AI exchange 500 is indirectly coupled to model registry 508 through network infrastructure 222. Cloud exchange 200 may also include a programmable network platform (not shown for simplicity purposes), such as programmable network platform 120 of FIG. 1.

Providers of data sets, machine learning algorithms and AI models (collectively “data”), such as cloud service providers 110A-N, may access AI exchange 500 in cloud exchange 200 through network infrastructure 222 to place their data into AI exchange 500. Consumers, such as customers 108A and 108B may access AI exchange through network infrastructure 222 to purchase access to data.

In the example of FIG. 2, network infrastructure 222 represents the cloud exchange switching fabric and includes multiple ports that may be dynamically interconnected with virtual circuits by, e.g., invoking a service interface of the programmable network platform (not shown). Each of the ports may be associated with one of carriers 106, customers 108, and cloud service providers 110.

In some examples, a cloud exchange seller (e.g., an enterprise or a cloud service provider nested in a cloud service provider) may request and obtain an L3 instance, and may then create a seller profile associated with the L3 instance, and subsequently operate as a seller on the cloud exchange. The techniques of this disclosure enable multiple cloud service providers to participate in an enterprise's L3 instance (e.g., an L3 “routed instance” or L2 “bridged instance”) without each cloud service provider flow being anchored with an enterprise device.

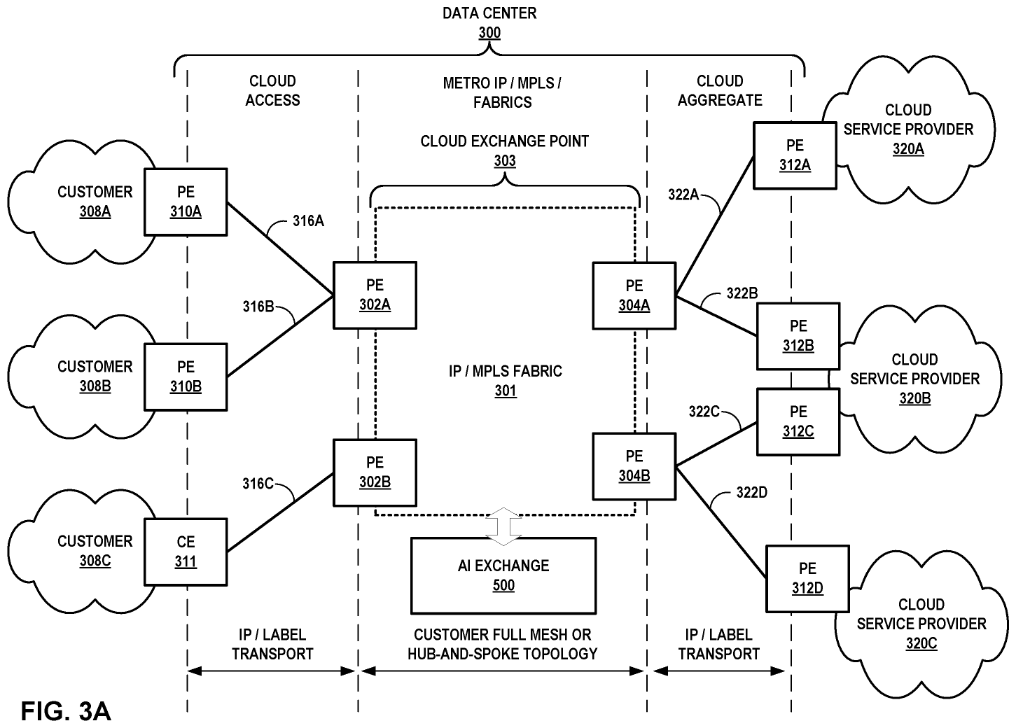

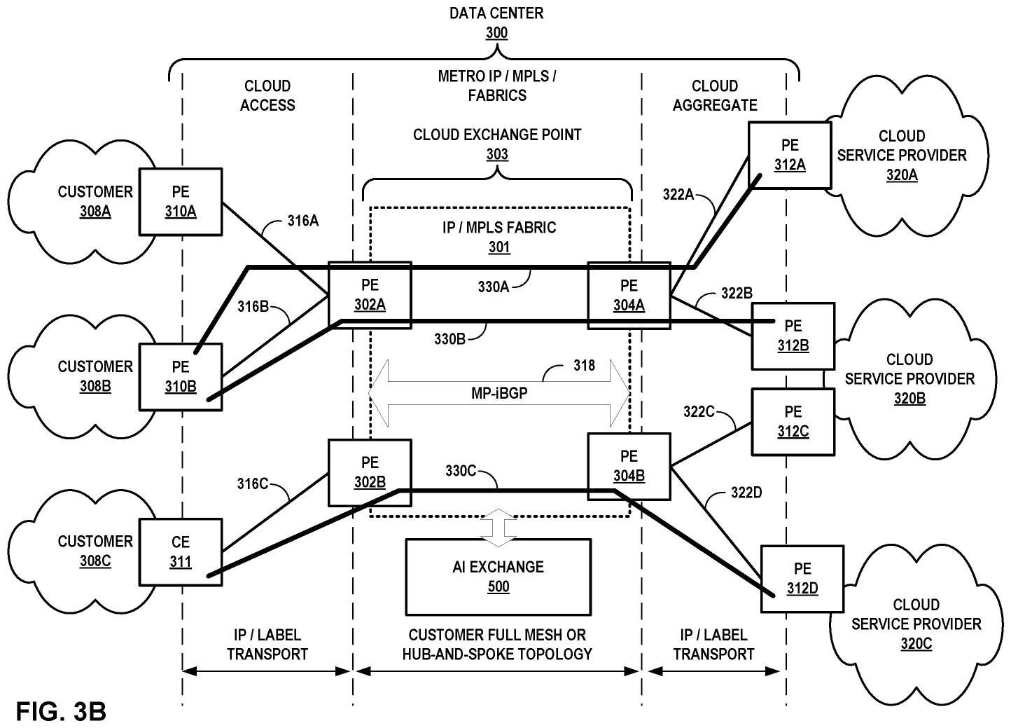

FIGS. 3A-3B are block diagrams illustrating example network infrastructure for a cloud exchange that includes an AI exchange 500 and enables access to AI exchange 500 to multiple providers of data sets, machine learning algorithms and AI models and to consumers of data sets, machine learning algorithms and AI models, in accordance with techniques described in this disclosure. In this example, customer networks 308A-308C (collectively, “customer networks 308”), each associated with a different customer, access a cloud exchange point within a data center 300 in order to access AI exchange 500 and securely access data sets, machine learning algorithms, and AI models contained within AI exchange 500. Customer networks 308 may each include endpoint devices (not shown for simplicity purposes) that may access AI exchange 500. Example endpoint devices include servers, smart phones, workstations, laptop/tablet computers, and so forth. Cloud service providers 320A-320C (collectively, “cloud service providers 320”) may access cloud exchange point 303 within a data center 300 in order to access AI exchange 500 for example, to provide data sets, machine learning algorithms, and AI models to, or to train AI models in, AI exchange 500.

Customer networks 308A-308B include respective provider edge/autonomous system border routers (PE/ASBRs) 310A-310B. Each of PE/ASBRs 310A, 310B may execute exterior gateway routing protocols to peer with one of PE routers 302A-302B (“PE routers 302” or more simply “PEs 302”) over one of access links 316A-316B (access links 316A-316C may be collectively referred to as, “access links 316”). In the illustrated examples, each of access links 316 represents a transit link between an edge router of a customer network 308 and an edge router (or autonomous system border router) of cloud exchange point 303. For example, PE/ASBR 310A and PE router 302A may directly peer via an exterior gateway protocol, e.g., exterior BGP, to exchange L3 routes over access link 316A and to exchange L3 data traffic between customer network 308A and cloud service provider networks 320. Access links 316 may in some cases represent and alternatively be referred to as attachment circuits for Internet Protocol-Virtual Private Networks (IP-VPNs) configured in Internet Protocol/Multiprotocol Label Switching (IP/MPLS) fabric 301, as described in further detail below. Access links 316 may in some cases each include a direct physical connection between at least one port of a customer network 308 and at least one port of cloud exchange point 303, with no intervening transit network. Access links 316 may operate over a virtual local area network (VLAN) or a stacked VLAN (e.g, QinQ tunneling), a virtual extensive local area network (VxLAN), a label switched path (LSP), a generic routing encapsulation (GRE) tunnel, or other type of tunnel.

While illustrated and primarily described with respect to L3 connectivity, PE routers 302 may additionally offer, via access links 316, L2 connectivity between customer networks 308 and cloud service provider networks 320. For example, a port of PE router 302A may be configured with an L2 interface that provides, to customer network 308A, L2 connectivity to cloud service provider 320A via access link 316A, with PE router 312A coupled to a port of PE router 304A that is also configured with an L2 interface. The port of PE router 302A may be additionally configured with an L3 interface that provides, to customer network 308A, L3 connectivity to cloud service provider 320B via access link 316A. PE router 302A may be configured with multiple L2 and/or L3 sub-interfaces.

Each of access links 316 and aggregation links 322A-322D (collectively, aggregation links 322) may include a network interface device (NID) that connects customer networks 308 or cloud service providers 320 to a network link between the NID and one of PE routers 302 or PE routers 304A-D (collectively “PE routers 304” or more simply “PEs 304”). Each of access links 316 and aggregation links 322 may represent or include any of a number of different types of links that provide L2 and/or L3 connectivity.

In this example, customer network 308C is not an autonomous system having an autonomous system number. Customer network 308C may represent an enterprise, network service provider, or other customer network that is within the routing footprint of cloud exchange point 303. Customer network includes a customer edge (CE) device 311 that may execute exterior gateway routing protocols to peer with PE router 302B over access link 316C. In various examples, any of PE/ASBR 310A-310B may alternatively be or otherwise represent CE devices.

Access links 316 include physical links. PE/ASBRs 310A-310B, CE device 311, and PE routers 302A-302B exchange L2/L3 packets via access links 316. In this respect, access links 316 constitute transport links for AI exchange access via cloud exchange point 303. Cloud exchange point 303 may represent an example of any of cloud exchange points 128. Data center 300 may represent an example of data center 201.

Cloud exchange point 303, in some examples, aggregates customers 308 access to the cloud exchange point 303 and to AI exchange 500 and data sets, machine learning algorithms and AI models of any one or more cloud service providers 320. FIGS. 3A-3B, e.g., illustrate access links 316A-316B connecting respective customer networks 308A-308B to PE router 302A of cloud exchange point 303 and access link 316C connecting customer network 308C to PE router 302B. Any one or more of PE routers 302, 304 may comprise ASBRs. PE routers 302, 304 and IP/MPLS fabric 301 may be configured to interconnect any of access links 316 and any of aggregation links 322 to AI exchange 500. As a result, cloud service provider network 320A, e.g., needs only to have configured a single cloud link (here, aggregation link 322A) in order to provide data sets, machine learning algorithms, and AI models to multiple customer networks 308 through AI exchange 500.

In addition, a single customer network, e.g., customer network 308A, need only to have configured a single cloud access link (here, access link 316A) to the cloud exchange point 303 within data center 300 in order to access AI exchange 500 and data sets, machine learning algorithms and AI models from a plurality of cloud service provider networks 320 offering cloud services via the cloud exchange point 303.

Cloud service provider networks 320 each include servers configured to provide one or more cloud services to users, such as the provision of data sets, machine learning algorithms and AI models. Cloud service provider networks 320 include PE routers 312A-312D (collectively “PE routers 312”) that each executes an exterior gateway routing protocol, e.g., eBGP, to exchange routes with PE routers 304A-304B (collectively, “PE routers 304”) of cloud exchange point 303. Each of cloud service provider networks 320 may represent a public, private, or hybrid cloud. Each of cloud service provider networks 320 may have an assigned autonomous system number or be part of the autonomous system footprint of cloud exchange point 303.

In the illustrated example, IP/MPLS fabric 301 interconnects PEs 302 and PEs 304 to AI exchange 500. IP/MPLS fabric 301 include one or more switching and routing devices, including PEs 302, 304, that provide IP/MPLS switching and routing of IP packets to form an IP backbone. In some example, IP/MPLS fabric 301 may implement one or more different tunneling protocols (i.e., other than MPLS) to route traffic among PE routers and/or associate the traffic with different IP-VPNs. In accordance with techniques described herein, IP/MPLS fabric 301 implements IP virtual private networks (IP-VPNs) to connect any of customers 308 to AI exchange 500 or multiple cloud service provider networks 320 to provide a data center-based ‘transport’ and layer 3 connection.

Whereas service provider-based IP backbone networks require wide-area network (WAN) connections with limited bandwidth to transport service traffic from layer 3 services providers to customers, the cloud exchange point 303 as described herein ‘transports’ service traffic and connects cloud service providers 320 to AI exchange 500 and to customers 308 within the high-bandwidth local environment of data center 300 provided by a data center-based IP/MPLS fabric 301. In some example configurations, a customer network 308 and cloud service provider network 320 may connect via respective links to the same PE router of IP/MPLS fabric 301.

Access links 316 and aggregation links 322 may include attachment circuits that associate traffic, exchanged with the connected customer network 308 or cloud service provider network 320, with virtual routing and forwarding instances (VRFs) configured in PEs 302, 304 and corresponding to IP-VPNs operating over IP/MPLS fabric 301. For example, PE router 302A may exchange IP packets with PE/ASBR 310A on a bidirectional label-switched path (LSP) operating over access link 316A, the LSP being an attachment circuit for a VRF configured in PE router 302A. As another example, PE router 304A may exchange IP packets with PE router 312A on a bidirectional label-switched path (LSP) operating over aggregation link 322A, the LSP being an attachment circuit for a VRF configured in PE router 304A. Each VRF may include or represent a different routing and forwarding table with distinct routes.

PE routers 302, 304 of IP/MPLS fabric 301 may be configured in respective hub-and-spoke arrangements for cloud services, with PEs 304 implementing cloud service hubs and PEs 302 being configured as spokes of the hubs (for various hub-and-spoke instances/arrangements). A hub-and-spoke arrangement ensures that service traffic is enabled to flow between a hub PE and any of the spoke PEs, but not directly between different spoke PEs. As described further below, in a hub-and-spoke arrangement for data center-based IP/MPLS fabric 301 and for southbound service traffic (i.e., from a cloud service provider to a customer) PEs 302 advertise routes, received from PE/ASBRs 310A-310B, to PEs 304, which advertise the routes to PEs 312. For northbound service traffic (i.e., from a customer to a cloud service provider), PEs 304 advertise routes, received from PEs 312, to PEs 302, which advertise the routes to PE/ASBRs 310A-310B.

For some customers of cloud exchange point 303, the cloud exchange point 303 provider may configure a full mesh arrangement whereby a set of PEs 302, 304 each couple to a different customer site network for the customer. In such cases, the IP/MPLS fabric 301 implements a layer 3VPN (L3VPN) for cage-to-cage or redundancy traffic (also known as east-west or horizontal traffic). The L3VPN may effectuate a closed user group whereby each customer site network can send traffic to one another but cannot send or receive traffic outside of the L3VPN.

PE routers may couple to one another according to a peer model without use of overlay networks. That is, PE/ASBRs 310A-310B and PEs 312 may not peer directly with one another to exchange routes, but rather indirectly exchange routes via IP/MPLS fabric 301. In the example of FIG. 3B, cloud exchange point 303 is configured to implement multiple layer 3 virtual circuits 330A-330C (collectively, “virtual circuits 330”) to interconnect customer network 308 and cloud service provider networks 320 with end-to-end IP paths. Each of cloud service providers 320 and customers 308 may be an endpoint for multiple virtual circuits 330, with multiple virtual circuits 330 traversing one or more attachment circuits between a PE/PE or PE/CE pair for the IP/MPLS fabric 301 and the cloud service provider/customer. A virtual circuit 330 represents a layer 3 path through IP/MPLS fabric 301 between an attachment circuit connecting a customer network to the fabric 301 and an attachment circuit connecting a cloud service provider network to the fabric 301. Each virtual circuit 330 may include at least one tunnel (e.g., an LSP and/or Generic Route Encapsulation (GRE) tunnel) having endpoints at PEs 302, 304. PEs 302, 304 may establish a full mesh of tunnels interconnecting one another.

Each virtual circuit 330 may include a different hub-and-spoke network configured in IP/MPLS network 301 having PE routers 302, 304 exchanging routes using a full or partial mesh of border gateway protocol peering sessions, in this example a full mesh of Multiprotocol Interior Border Gateway Protocol (MP-iBGP) peering sessions. MP-iBGP or simply MP-BGP is an example of a protocol by which routers exchange labeled routes to implement MPLS-based VPNs. However, PEs 302, 304 may exchange routes to implement IP-VPNs using other techniques and/or protocols.

In the example of virtual circuit 330A, PE router 312A of cloud service provider network 320A may send a route for cloud service provider network 320A to PE router 304A via a routing protocol (e.g., eBGP) peering connection with PE router 304A. PE router 304A associates the route with a hub-and-spoke network, which may have an associated VRF, that includes spoke PE router 302A. PE router 304A then exports the route to PE router 302A; PE router 304A may export the route specifying PE router 304A as the next hop router, along with a label identifying the hub-and-spoke network. PE router 302A sends the route to PE/ASBR 310B via a routing protocol connection with PE/ASBR 310B. PE router 302A may send the route after adding an autonomous system number of the cloud exchange point 303 (e.g., to a BGP autonomous system path (AS_PATH) attribute) and specifying PE router 302A as the next hop router. Cloud exchange point 303 is thus an autonomous system “hop” in the path of the autonomous systems from customers 308 to cloud service providers 320 (and vice-versa), even though the cloud exchange point 303 may be based within a data center. PE/ASBR 310B installs the route to a routing database, such as a BGP routing information base (RIB) to provide layer 3 reachability to cloud service provider network 320A. In this way, cloud exchange point 303 “leaks” routes from cloud service provider networks 320 to customer networks 308, without cloud service provider networks 320 to customer networks 308 requiring a direct layer peering connection.

PE/ASBR 310B, and PE routers 302A, 304A, and 312A may perform a similar operation in the reverse direction to forward routes originated by customer network 308B to PE router 312A and thus provide connectivity from cloud service provider network 320A to customer network 308B. In the example of virtual circuit 330B, PE routers 312B, 304A, 302A, and PE/ASBR 310B exchange routes for customer network 308B and cloud service provider 320B in a manner similar to that described above for establishing virtual circuit 330B. As a result, cloud exchange point 303 within data center 300 internalizes the peering connections that would otherwise be established between PE/ASBR 310B and each of PE routers 312A, 312B so as to perform cloud aggregation for multiple layer 3 cloud services provided by different cloud service provider networks 320A, 320B and deliver the multiple, aggregated layer 3 cloud services to a customer network 308B having a single access link 316B to the cloud exchange point 303.

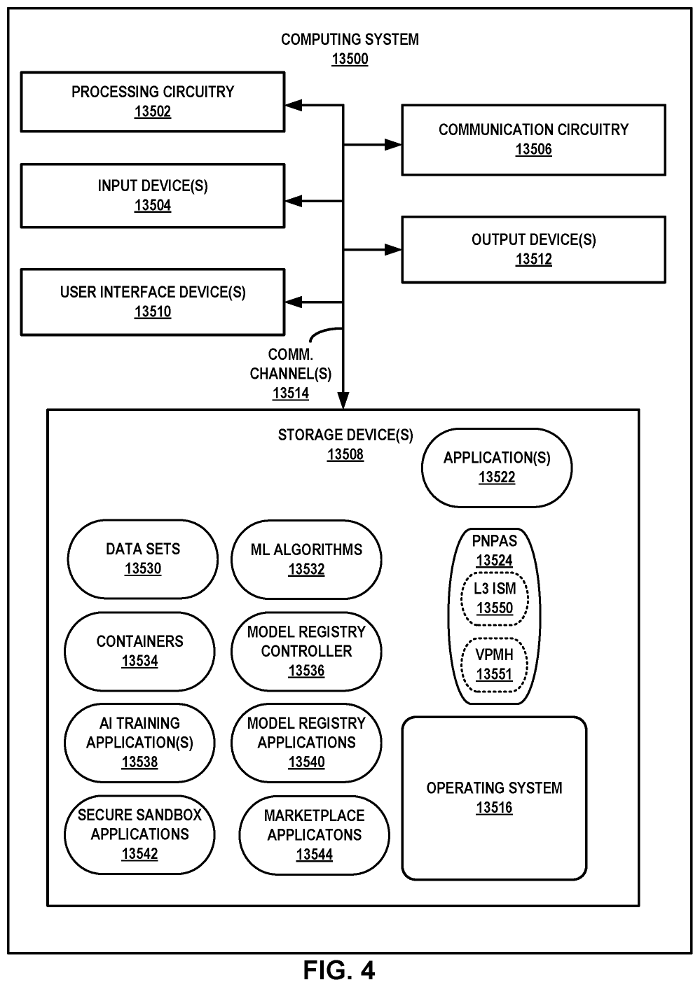

FIG. 4 is a block diagram illustrating further details of one example of a computing device that operates in accordance with one or more techniques of the present disclosure. FIG. 4 may illustrate a particular example of a server or other computing device 13500 that includes processing circuitry 13502, which may include one or more processors, that may execute any one or more of the programmable network platform components, or any other system, application, or module described herein. Other examples of computing device 13500 may be used in other instances. Although shown in FIG. 4 as a stand-alone computing device 13500 for purposes of example, a computing device may be any component or system that includes one or more processors or other suitable computing environment for executing software instructions and, for example, need not necessarily include one or more elements shown in FIG. 4 (e.g., communication circuitry 13506; and in some examples components such as one or more storage devices 13508 may not be co-located or in the same chassis as other components). Computing device 13500 is an example device that may implement AI exchange 500, model registry 508 or any portion of AI exchange 500 or model registry 508 according to the techniques of this disclosure.

As shown in the specific example of FIG. 4, computing device 13500 includes processing circuitry 13502, one or more input devices 13504, one or more communication circuitry 13506, one or more output devices 13512, one or more storage devices 13508, and one or more user interface (UI) devices 13510. In some examples, computing device 13500 further includes data sets 13530 and machine learning algorithms 13532 that may be provided to computing system 13500 by cloud service providers, such as cloud service providers 320A-C. Computing device 13500 may also include containers 13534. Containers 13534 may contain a plurality of containers, each containing an AI model, AI model metadata associated with the AI model and a hash unique to the specific AI model as trained. In the case where computing device 13500 implements AI exchange 500, computing device 13500 may also contain model registry controller 13536, which may be used by AI exchange 500 to interface with model registry 508, AI training application(s) 13538, which may be used to train AI models, secure sandbox applications 13542, which may be used to implement a secure sandbox for conducting AI model transactions, and marketplace applications 13544, which may be used to implement a marketplace for data sets 13530, machine learning algorithms 13532 and AI models within containers 13534. In the case where computing device 13500 implements model registry 508, computing device 13500 may include model registry applications 13540, such as a model registry API gateway, blockchain applications, and blockchain ledger(s) discussed later herein.

Computing device 13500 may also include one or more applications 13522 for performing other functions, programmable network platform application(s) (PNPAS) 13524, and operating system 13516. Each of the applications in one or more storage devices 13508 and operating system 13516 may be executable by computing device 13500. Each of the components of computing system 13500, such as processing circuitry 13502, one or more input devices 13504, communication circuitry 13506, one or more storage devices 13508, one or more UI devices 13510, and one or more output devices 13512 are coupled (physically, communicatively, and/or operatively) for inter-component communications. In some examples, one or more communication channels 13514 may include a system bus, a network connection, an inter-process communication data structure, or any other method for communicating data between components. As one example, each of the components of computing system 13500, such as processing circuitry 13502, one or more input devices 13504, communication circuitry 13506, one or more storage devices 13508, one or more UI devices 13510, and one or more output devices 13512, may be coupled by one or more communication channels 13514.

Processing circuitry 13502, in one example, are configured to implement functionality and/or process instructions for execution within computing device 13500. For example, processing circuitry 13502 may be capable of processing instructions stored in one or more storage devices 13508. Examples of processing circuitry 13502 may include, any one or more of a microprocessor, a controller, a digital signal processor (DSP), an application specific integrated circuit (ASIC), a field-programmable gate array (FPGA), or equivalent discrete or integrated logic circuitry.

One or more storage devices 13508 may be configured to store information within computing device 13500 during operation. One or more storage devices 13508, in some examples, is described as a computer-readable storage medium. In some examples, one or more storage devices 13508 is a temporary memory, meaning that a primary purpose of one or more storage devices 13508 is not long-term storage. One or more storage devices 13508, in some examples, is described as a volatile memory, meaning that one or more storage devices 13508 does not maintain stored contents when the computer is turned off. Examples of volatile memories include random access memories (RAM), dynamic random access memories (DRAM), static random access memories (SRAM), and other forms of volatile memories known in the art. In some examples, one or more storage device 13508 is used to store program instructions for execution by processing circuitry 13502. One or more storage device 13508, in one example, is used by software or applications running on computing device 13500 to temporarily store information during program execution.

One or more storage devices 13508, in some examples, also include one or more computer-readable storage media. One or more storage devices 13508 may be configured to store larger amounts of information than volatile memory. One or more storage devices 13508 may further be configured for long-term storage of information. In some examples, one or more storage devices 13508 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 13500, in some examples, also includes one or more communication circuitry 13506. Computing device 13500, in one example, utilizes communication circuitry 13506 to communicate with external devices via one or more networks, such as one or more wired/wireless/mobile networks. Communication circuitry 13506 may include a network interface card, such as an Ethernet card, an optical transceiver, a radio frequency transceiver, or any other type of device that can send and receive information. In some examples, computing device 13500 uses communication circuitry 13506 to communicate with an external device.

Computing device 13500, in one example, also includes one or more UI devices 13510. One or more UI devices 13510, in some examples, are configured to receive input from a user through tactile, audio, or video feedback. Examples of one or more UI devices 13510 include a presence-sensitive display, a mouse, a keyboard, a voice responsive system, video camera, microphone or any other type of device for detecting a command from a user. In some examples, a presence-sensitive display includes a touch-sensitive screen.

One or more output devices 13512 may also be included in computing device 13500. On or more output devices 13512, in some examples, is configured to provide output to a user using tactile, audio, or video stimuli. One or more output devices 13512, in one example, includes a presence-sensitive display, a sound card, a video graphics adapter card, or any other type of device for converting a signal into an appropriate form understandable to humans or machines. Additional examples of one or more output devices 13512 include a speaker, a cathode ray tube (CRT) monitor, a liquid crystal display (LCD), or any other type of device that can generate intelligible output to a user.

Computing device 13500 may include operating system 13516. Operating system 13516, in some examples, controls the operation of components of computing device 13500. For example, operating system 13516, in one example, facilitates the communication of one or more applications 13522 and programmable network platform application(s) 13524 with processing circuitry 13502, communication circuitry 13506, one or more storage devices 13508, one or more input devices 13504, one or more UI devices 13510, and one or more output devices 13512.

Applications 13522 and programmable network platform application(s) 13524 may also include program instructions and/or data that are executable by computing device 13500. Example programmable network platform application(s) 13524 executable by computing device 13500 may include L3 instance as a service module 13550 and virtual performance hub module 13551.

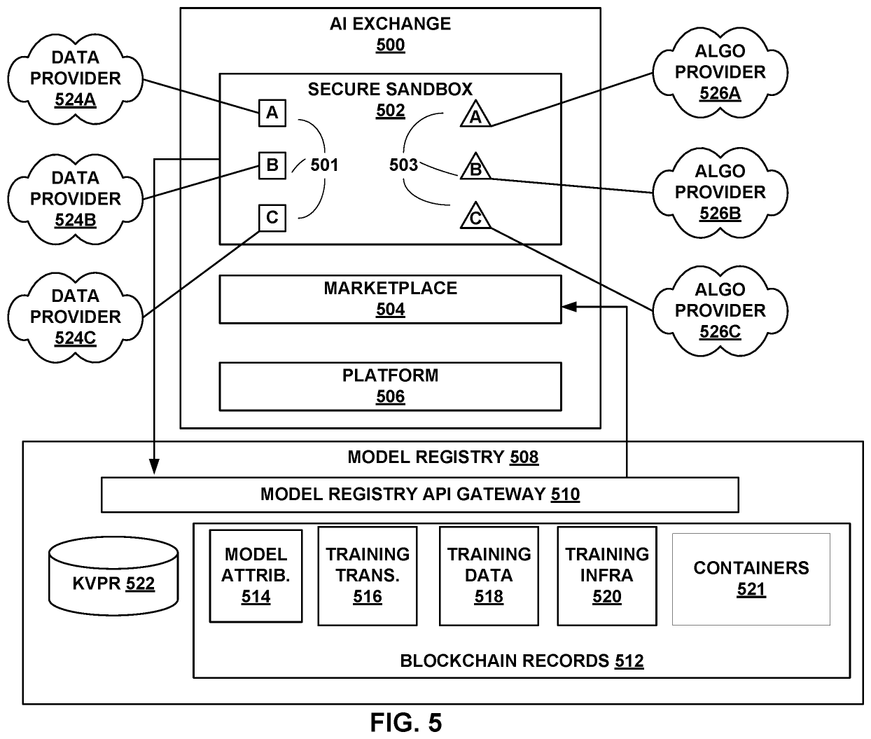

FIG. 5 is a block diagram illustrating an example AI exchange system according to techniques of the present disclosure. AI exchange 500 may contain secure sandbox 502, marketplace 504, and platform 506. AI exchange 500 may be a private or independent system available to members of a consortium seeking access to AI algorithms, data sets, or AI models of others to develop existing AI models to better suit their needs or to utilize AI models developed by others. AI exchange 500 may provide members of the consortium, such as data scientists, with a secure environment for creating and training AI models in a secure manner that enables future prospective users of a trained AI model to verify the provenance and characteristics of the trained AI model, e.g., without such prospective users having to train the AI models themselves. Data providers 524A-C are shown coupled to secure sandbox 502. Data providers 524A-C may provide data sets 501A-C respectively to secure sandbox 502. Algorithm providers (Algo providers) 526A-C are also shown coupled to secure sandbox 502. Algorithm providers 526A-C may provide machine learning algorithms to secure sandbox 502. Secure sandbox 502 may be an area where customers, such as customers 108A-C (of FIGS. 1-2) may access machine learning algorithms and data sets, such as machine learning algorithms 503A-C and data sets 501A-C. Customers may also access AI models existing within secure sandbox 502 (not shown in FIG. 5). Data providers 524A-C and algorithm providers 526A-C may be cloud service providers, such as cloud service providers 110A-N of FIG. 1, enterprises, academic institutions, individuals, or other providers. In some examples, one or more of data providers 524A-C or algorithm providers 526A-C may also be customers, such as customers 108A-C of FIG. 1.

In some examples, marketplace 504 may be provided by a cloud service provider, such as cloud service providers 110A-N. In some examples, AI exchange 500 may include a plurality of marketplaces 504. In some examples, marketplace 504 may be directed to a particular industry segment, such as the airline market, healthcare market, oil and gas market, autonomous vehicle market, etc. Marketplace 504 may be operated by a consortium of companies, universities, individuals and/or other entities with an interest in AI models and/or data sets within the industry segment that marketplace 504 services, for example, the airline industry. AI exchange 500 may be provided by a neutral, independent entity as a PaaS, for example.

AI exchange 500 may be coupled to model registry 508. In some examples, model registry 508 may be implemented inside secure sandbox 502. Model registry 508 may be a blockchain-based registry that registers AI models and validates AI model metadata. Model registry 508 may maintain key AI model metadata for operations performed with various AI models in AI exchange 500. Model registry 508 may contain model registry application programming interface (API) gateway 510, key value pair registry database (KVPR) 522 and blockchain records 512 (e.g., a blockchain ledger). In some examples, blockchain records 512 may contain records containing AI model metadata such as model attributes 514, training transactions 516, training data usage 518 and training infrastructure 520. In other examples, blockchain records may contain records of containers 521 which each contain an AI model, along with related AI model metadata and a related hash. In some examples, blockchain records 512 may contain model attributes 514, training transactions 516, training data usage 518 and training infrastructure 520 and containers 521.

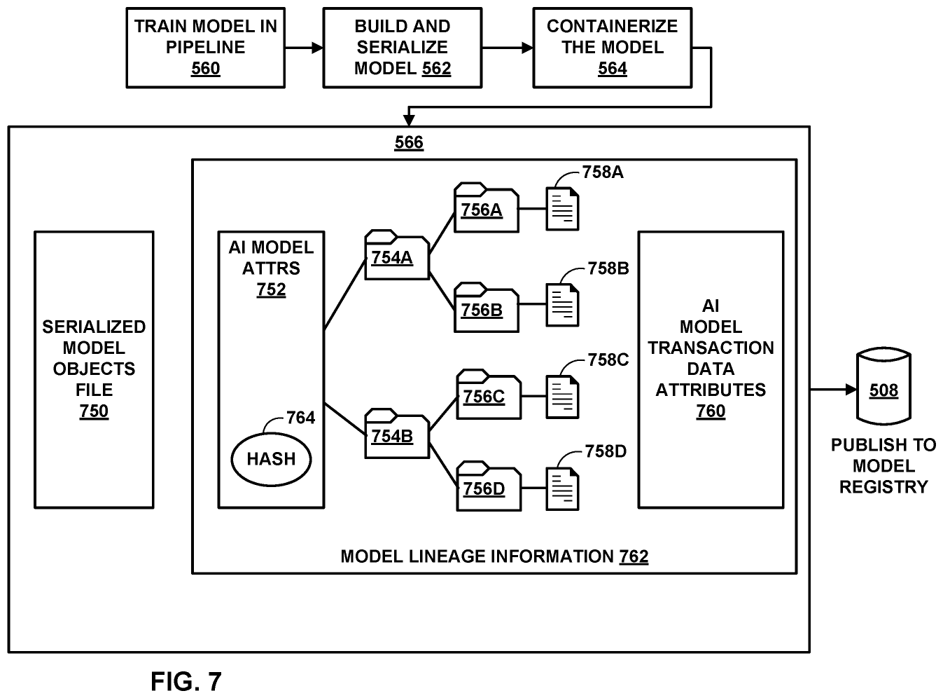

An AI model within secure sandbox 502 may be packaged inside a container, along with its associated AI model metadata and a hash, which may be used to validate the AI model and the AI model metadata. The containerizing of AI models will be discussed in more detail hereinafter with respect to FIG. 7.

AI models may be developed and enhanced in multiple phases. For example, a data scientist may build an initial AI model using an AI algorithm and a small data set. The AI model may subsequently be deployed in a production or industrial environment and be refined using larger data sets by, for example, an operations team. Thus, there are many transactions that may occur involving a particular AI model within secure sandbox 502. Transactions within secure sandbox 502, such as training of a model on a particular data set, may be monitored by AI exchange 500 and may be recorded as AI model metadata in a container and in model registry 508. Secure sandbox 502 may provide the AI model metadata to model registry 508 through model registry API gateway 510. New metadata may be added to existing metadata for the AI model that, for example, was further trained, and the resulting AI model, the combined metadata and a new hash based on the resulting AI model may be containerized. Data scientist workflow and production deployment of an AI model workflow inside secure sandbox 502 may be implemented as pipelines using an orchestrator, such a Kubeflow. Additionally, the containerization process may be implemented using such an orchestrator. Secure sandbox 502 may restrict unauthorized data sets, AI algorithms, AI models, and AI model building or refining from secure sandbox 502 and attempt to ensure that every transaction involving an AI model is recorded. An AI model that is built in secure sandbox 502 and trained in secure sandbox 502 may be referred to herein as a secure AI model and the AI metadata associated with the secure AI model may be referred to herein as secure AI model metadata.

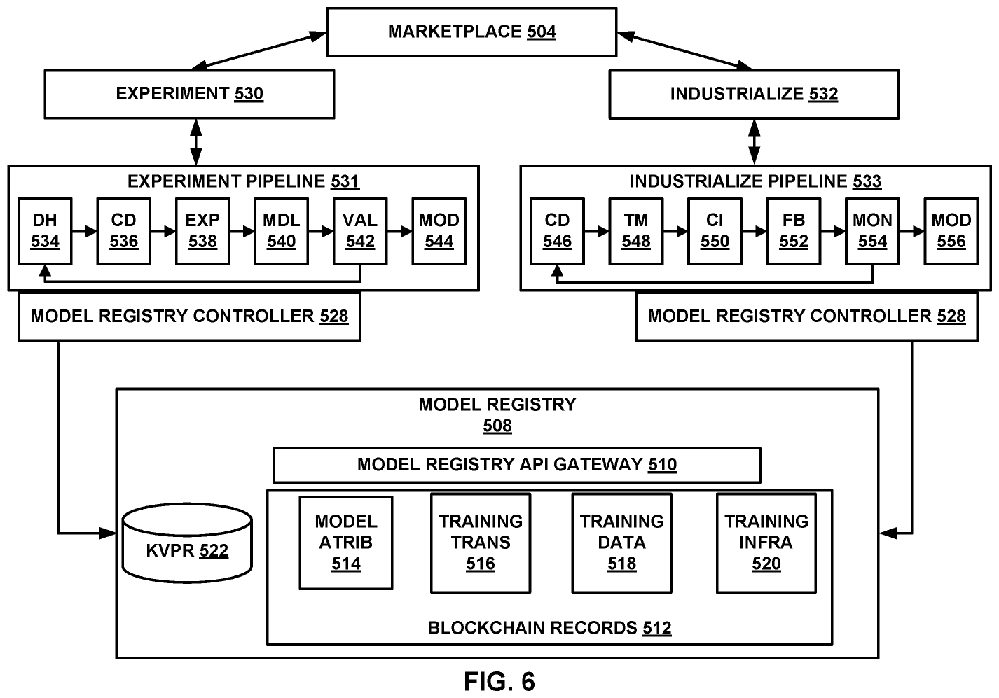

FIG. 6 is a block diagram depicting an example pipeline update process according to techniques of this disclosure. FIG. 6 depicts two separate pipelines: an experiment pipeline 531 and an industrialize pipeline 533. A data scientist, from a member of a consortium for example, may access experiment pipeline 531 through marketplace 504 by, for example, selecting an experiment option 530. While not shown in FIG. 6, experiment pipeline 531 may be located in secure sandbox 502. The data scientist may begin by defining a hypothesis (DH) 534. The hypothesis may be a problem statement or a use case. For example, the data scientist may define as a hypothesis how can traffic flow be increased during rush hour in a particular location. The data scientist may then collect data (CD) 536. Collect data 536 may involve ingesting data, such as data set 501A, or may involve the data scientist importing data external to AI exchange 500 into secure sandbox 502, if the data scientist is authorized to import that particular data.

The data scientist may explore (EXP) 538. Explore 538 may involve data analysis and/or cleansing. For example, the data scientist may analyze the data being used and realize that there is outlying data in the data set and remove the outlying data. The data scientist may perform modeling (MDL) 540. Modeling 540 may involve feature identification. For example, the data scientist may identify that traffic circles may have a different effect on traffic flow than traffic lights. The data scientist may also validate (VAL) 542. Validate 542 may involve testing the model and evaluating the results. If the results are poor in the data scientist's opinion, the data scientist may iterate and improve the hypothesis by returning to defining a hypothesis 534. If the results are acceptable in the data scientist's opinion, the data scientist may choose to keep the model (MOD) 544.

As discussed with respect to FIG. 5, each of the transactions conducted in experiment pipeline 531 by the data scientist may be recorded. Experiment pipeline 531 may engage model registry controller 528 to record these transactions in model registry 508 through, for example, model registry API gateway 510. In some examples, the transactions may be recorded in containers 521 as shown in FIG. 5. In some examples, the transactions may be recorded in model attributes 514, training transactions 516, training data usage 518 and training infrastructure 520.

A data scientist or operations personnel (the “user”), from a member of a consortium for example, may similarly access industrialize pipeline 533 through marketplace 504 by selecting the industrialize option 532. While not shown in FIG. 6, industrialize pipeline may be located in secure sandbox 502. The user may select an AI model available in the secure sandbox and collect data (CD) 546. Collect data 546 may involve ingestion of a production data set(s). In some examples, the production data sets may be larger data sets than the data set used for collect data 536 in experiment pipeline 531. The production data sets may be data sets such as data sets 501A-C or may be data set(s) imported by the user if the user has authority to import the data sets into secure sandbox 502. The user may train model (TM) 548. Train model 548 may involve running the AI model on the data from collect data 546. For example, the user may train an AI model using an AI training application 13538. The user may continue integration (CI) 550. Continue integration 550 may involve operationalizing the AI model, such as creating a representational state transfer (REST) API or an auto run feature.

The user may determine feedback (FB) 552. Feedback 552 may involve assessing the model and may involve making a collaborative and informed decision on the efficacy of the AI model. For example, the user may consult colleagues or other consortium members regarding the efficacy of the AI model. The user may also monitor (MON) 554. Monitor 554 may involve monitoring the performance of the AI model and conducting testing on the AI model. The user may determine to maintain and improve the model, in which case the user may return to collect data 546. In some examples, the user may be fully satisfied with the AI model and may wish to deploy model (MOD) 556 into the field. For example, the user may export AI model 556 from AI exchange 500 to a server resident on an enterprise network at the user's place of work. In some examples, the user may export AI model 556 to multiple servers which may be located in multiple locations. If desired, the user may later contact model registry 508 to validate the metadata associated with AI model 556.

As with experiment pipeline 531, each of the transactions within industrialize pipeline 533 may be recorded. Industrialize pipeline 533 may engage model registry controller 528 to record these transactions in model registry 508 through, for example, model registry API gateway 510. In some examples, the transactions may be recorded in containers 521 as shown in FIG. 5. In some examples, the transactions may be recorded in model attributes 514, training transactions 516, training data usage 518 and training infrastructure 520.

FIG. 7 is a block diagram illustrating an example AI model container according to the techniques of this disclosure. A user may train an AI model in a pipeline, such as experiment pipeline 530 or industrialize pipeline 532 (560). The user may build the AI model and secure sandbox 502 may serialize the AI model (562). Secure sandbox 502 may then containerize the AI model (564). The container 566 may contain serialized AI model objects file 750 and AI model lineage information 762. In some examples, serialized AI model objects file 750 may be a PKL file(s). In some examples, AI model lineage information 762 may be stored in an HD5 format.

AI model lineage information 762 may include AI model attributes (AI model attrs) 752 and AI model transaction data attributes 760. In some examples, AI model attributes 752 may be stored in a JSON file format. AI model attributes 752 may include information pertaining to serialized AI model objects file 750 contained in container 566, such as a unique ID identifying serialized AI model objects file 750, the version of serialized AI model objects file 750 (e.g., each time serialized AI model objects file 750 is deserialized and trained, a new version of serialized AI model objects file 750 may be created and be given a new version number), an identification of who created the AI model represented by serialized AI model objects file 750, the category of the AI model (e.g., what type of AI model is the AI model), the type of algorithm used to create the AI model represented by serialized AI model objects file 750, the framework targeted by the AI model represented by serialized AI model objects file 750, a use case(s) for the AI model represented by serialized AI model objects file 750, a URL that may link to more information about the AI model represented by serialized AI model objects file 750, support details that may be helpful to users of the AI model represented by serialized AI model objects file 750, and usage and ratings information the AI model represented by serialized AI model objects file 750, etc. AI model attributes 752 may also include model hash 764 that may be used to verify serialized AI model objects file 750 and AI model lineage information 762.

AI model training data attributes 760 may contain information related to the training of the AI model represented by serialized AI model objects file 750. In some examples, AI model training data attributes 760 contains information related to every training transaction that occurs within secure sandbox 502 (e.g., experiment pipeline 530 and industrialize pipeline 532). For example, AI model training data attributes 760 may contain information regarding the training transactions of the AI model represented by serialized AI model objects file 750, such as training date and time, training duration, training geography (such as where the training physically occurred or where the data used to train originated from), a description of the training, the industry segment the training was meant to benefit, the configuration of any hyper parameters used, benchmark results, training use case(s) (e.g., what the use case was for the trainer of the AI model), the data set size of the training, the infrastructure used during the training, a cloud or natural flag (e.g., whether the training was performed on a cloud resource), and a flag that may identify whether the training was conducted in experiment pipeline 531 or industrialize pipeline 533, etc.

AI model attributes 752 and/or AI model transaction data attributes 760 may be stored in folders such as folders 754A-B and 756A-D. Folder 754A may contain metadata associated with transactions of providers of AI models. Folder 754B may contain metadata associated with transactions of consumers of AI models. Folders 756A-B may be subfolders of folder 754A and folders 756C-D may be subfolders of folder 754B. Folder 756A may contain metadata associated with internal training transactions, such as those of providers of AI models within the consortium, for example, AI model training metadata 758A. Folder 756B may contain metadata associated with external training transactions, such as those of providers outside of the consortium, for example, AI model training metadata 758B. Folder 756C may contain training metadata associated with internal training transactions of consumers, such as consumers that are members of the consortium, for example, AI model training metadata 758C. Folder 756D may contain training metadata associated with external training transactions of consumers, such as consumers that are not members of the consortium, for example AI model training metadata 758D. Alternatively, folders 756A and 756C may contain metadata related to training occurring within secure sandbox 502 and folders 756B and 756D may contain metadata related to training occurring outside of secure sandbox 502.

Container 566 may be published to model registry 508, e.g., through model registry controller 528 and model registry API gateway 510 (both of which are not shown in FIG. 7 for simplicity purposes). Model registry 508 may register a key value pair associated with container 566 in key value registry database 522 and may store container 566 in block chain records 512. Secure sandbox 502 may also store container 566 locally.

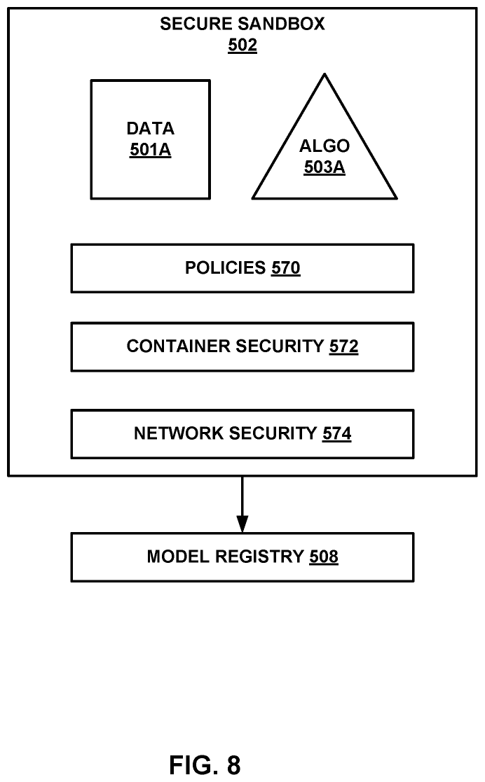

FIG. 8 is a block diagram illustrating security aspects of the secure sandbox according to the techniques of the present disclosure. Secure sandbox 502 may contain data sets, such as data set (data) 501A and machine learning algorithms, such as machine learning algorithm (algo) 503A. Secure sandbox 502 may also contain policies 570. Container security 572 may enforce policies 570 at the container level. Network security 574 may enforce policies 570 at the network level. Policies 570 may restrict the ingress and/or egress of data sets to and from secure sandbox 502. Policies 570 may also restrict the ingress and/or egress of machine learning algorithms to and from secure sandbox 502. Policies 570 may also restrict the ingress and/or egress of trained IA models to and from secure sandbox 502. Policies 570 may also restrict the identity of data set providers, machine learning algorithm providers and AI model providers. For example, network security 574 may enforce policies 570 to only permit previously authorized data set providers, machine learning algorithm providers and AI model providers to access secure sandbox 502. Policies 570 may also restrict model changes at a pipeline level or at an individual user level. For instance, network security 574 may enforce policies 570 to prevent changes to an existing AI model in a given pipeline, such as experiment pipeline 531 or prevent changes to an existing AI model by a particular user or class of users.

As previously discussed, all operations or transactions performed on an AI model in secure sandbox 502 may be tracked and stored in a container, such as container 566. Container 566 may be stored in model registry 508 (and/or secure sandbox 502) and include AI model metadata associated with the training of the AI model and any changes made to the AI model in either experiment pipeline 531 or industrialize pipeline 533. In some examples, model registry 508 may be implemented in secure sandbox 502. In some examples, a flag will also be stored indicating in which pipeline the transaction occurred. By tracking and storing all transactions that occur to an AI model in secure sandbox 502, secure sandbox 502 may accurately audit a lineage of a given AI model and AI exchange 500 may attest AI model lineage to a consumer of that AI model through the use of model registry 508.

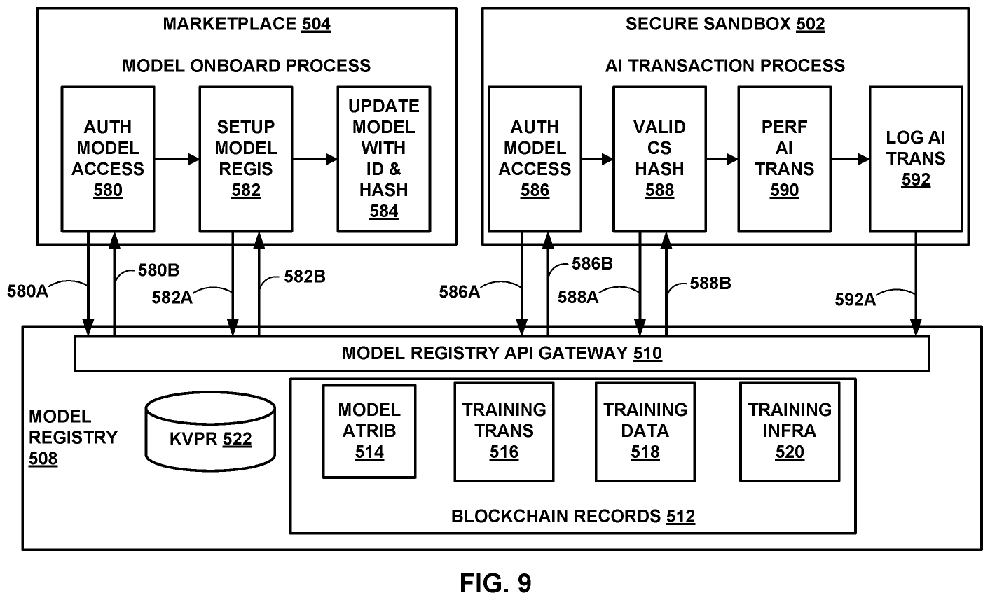

FIG. 9 is a conceptual diagram of an example model registry update and an example model usage process according to techniques of this disclosure. If a user wants to onboard an AI model, the user may enter marketplace 504. In some examples, marketplace 504 may attempt to authorize the AI model access (auth model access) (580) by sending an authorization request 580A to model registry 508 through model registry API gateway 510. In some examples, model registry 508 may be implemented within a secure sandbox, such as secure sandbox 502 of FIG. 5. Model registry 508 may respond by sending an authorization identity token 580B back to marketplace 504. The user, through marketplace 504, may then attempt to setup a model registry record (setup model regis) (582). Marketplace 504 may send a model setup request 582A to model registry 508 through model registry API gateway 510. Model setup request 582A may contain authorization identity token 580B.

In response to model setup request 582A, model registry 508 may generate an AI model unique ID and a hash. The hash may be based at least in part on the AI model. Model registry 508 may use any known techniques to generate the hash. Model registry 508 may send to marketplace 504 the AI model unique ID and hash 582B. Marketplace 504 may then update the local AI model with the AI model unique ID and hash 582B. The local AI model may be serialized, containerized with associated AI model metadata and an associated hash and stored in model registry 508. The local model may also be moved or copied into secure sandbox 502.

When a user wishes to perform an AI transaction, such as training an existing AI model, the user may access secure sandbox 502 to authorize the AI model access (586). Secure sandbox 502 may send an authorization request (auth model access) 586A to model registry 508 through model registry API gateway 510. Model registry 508 may send an authorization identity token 586B in response to authorization request 586A. Secure sandbox 502 may then attempt to validate the checksum hash (valid cs hash) (588). Secure sandbox 502 may send a message 588A to model registry 508 through model registry API gateway 510. Message 588A may contain a local model hash and authorization identity token 586B. In response to message 588A, model registry 508 may attempt to validate the local model hash. If model registry 508 validates the local model hash, model registry 508 may send secure sandbox 502 a hash validation response 588B. Based on receiving hash validation response 588B, secure sandbox 502 may permit the user to perform the AI transaction (perf AI trans) (590). Secure sandbox 502 may log the AI transaction (log AI trans) in model registry 508 (592). For example, secure sandbox 502 may send a message 592A to model registry 508 through model registry API gateway 510. Message 592A may include authorization identity token 586B and a registry update request containing AI model metadata associated the transaction, such as metadata discussed above with respect to FIG. 7. In some examples, secure sandbox 502 may containerize the AI model metadata associated with the transaction with the AI model and an updated hash prior to sending message 592A and message 592A may include authorization identity token 586B and the container. In some examples, model registry 508 may update the hash. In some example, secure sandbox 502 may update the hash.

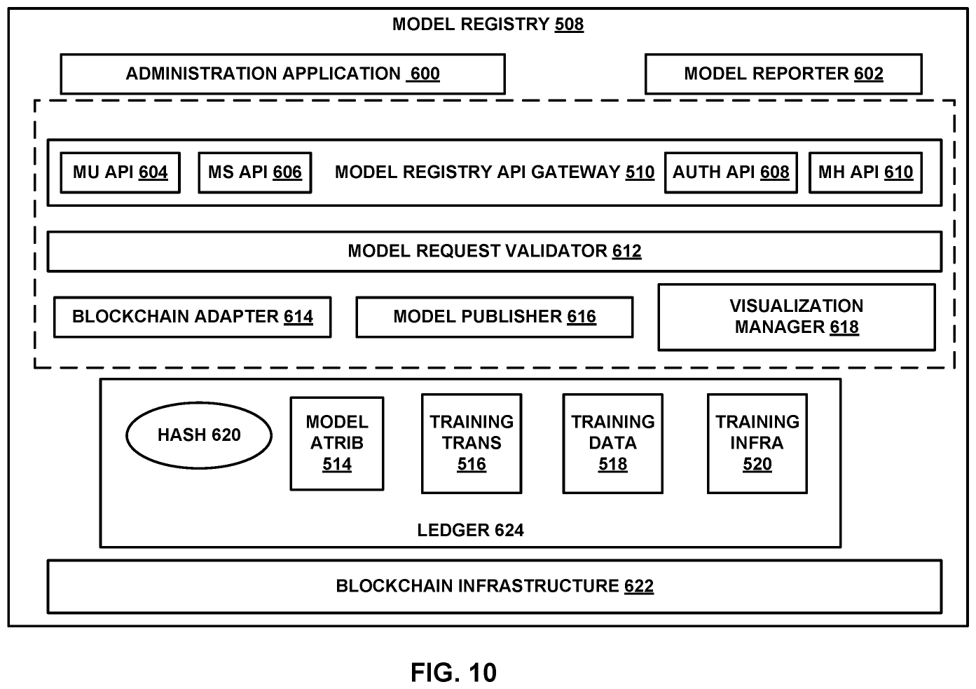

FIG. 10 is a block diagram of an example model registry according to techniques of this disclosure. Model registry 508 may contain administration application (admin app) 600, model reporter 602, model registry API gateway 510, model request validator 612, blockchain adopter 614, model publisher 616, visualization manager 618, ledger 624 and blockchain infrastructure 622. Administration application 600 may enable an administrator to program, monitor or otherwise interact with model registry 508. Model reporter 602 may provide secure sandbox 502 and/or marketplace 504 with information regarding AI models that have been registered in model registry 508.

As discussed above, model registry API gateway 510 may provide an API permitting secure sandbox 502 and marketplace 504 to communicate with model registry 502. Model registry API gateway 510 may include model update API (MU API) 604, model setup API (MS API) 606, authorization API (auth API) 608 and model history API (MH API) 610. Model update API 604 may be used by secure sandbox 502 and/or marketplace 504 to communicate updates to AI models. Model setup API 606 may be used by marketplace 504 when onboarding a model, such as was discussed above with respect to FIG. 9. Authorization API 608 may be used by secure sandbox 502 and marketplace 504 to request and receive authorization, such as was discussed above with respect to FIG. 9. Model history API 610 may be used by secure sandbox 502 and/or marketplace 504 to obtain information regarding an AI model's history or lineage.

Model request validator 612 may receive requests to validate an AI model. Model request validator 612 may access ledger 624 (through, for example, blockchain adapter 614) and locate the hash (in some examples located within a container) associated with the AI model, check the hash against the hash associated with the request and report the validation back to, for example, secure sandbox 502.

Blockchain adapter 614 may receive AI model metadata. In some examples, the AI model metadata may be in a container, such as container 566, including an AI model, the AI model metadata (e.g., model attributes 752 and model transaction data attributes 760), and a hash (e.g., hash 764) and may interact with blockchain infrastructure 622 so as to store the container in ledger 624. In some example, the AI model metadata may not be in a container. Model publisher 616 may publish models stored in containers in ledger 624 to secure sandbox 502 and/or marketplace 504. For example, model publisher 616 may send a serialized and containerized AI model to secure sandbox 502. Secure sandbox 502 may remove the serialized AI model from the container and may deserialize the serialized AI model, making the AI model available for use in secure sandbox 502. Model publisher 616 may also provide information, such as AI model metadata associated with an AI model, to marketplace 504, so as to permit users to view information regarding the AI models that may exist in secure sandbox 504. Visualization manager 618 may publish various analysis reports to consumers such as AI models available, which AI models have been updated, data sets available, etc.

By utilizing a blockchain-based model registry, model registry 508 may maintain immutable records of the AI models and associated AI model metadata contained within secure sandbox 502. Model registry 508 may utilize a hash-based validation process to restrict invalid AI model updates. As such, model registry 508 may be provided as PaaS, model registry API gateway 510 may be provided as SaaS and verification (attestation) of lineage or provenance of AI models may be provided as a service. Model registry 508 may support multiple marketplaces and multiple secure sandboxes, including marketplaces and secure sandboxes directed to different market segments, different data sets, different machine learning algorithms and different AI models. In some examples, model registry 508 may be built on top of a blockchain ledger such that each member of the related consortium may have an immutable copy of model registry 508.

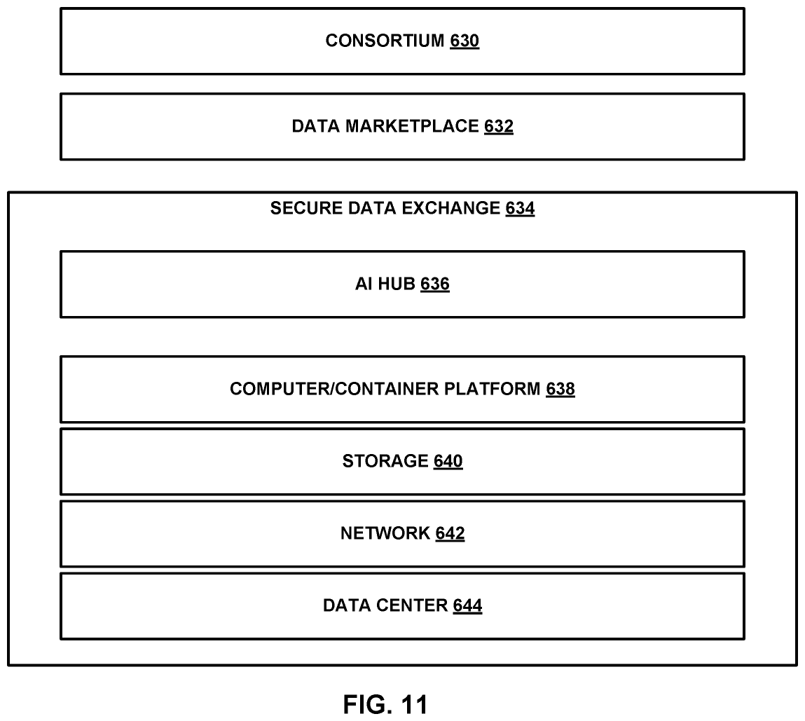

FIG. 11 is a conceptual diagram illustrating an example functional overview of an example AI exchange system (such as AI exchange 500) according to techniques of the present disclosure. It should be noted that this is merely an example functional overview and various functions and responsibilities may be handled differently in other examples.

The exchange system may be run by a consortium 630. Consortium 630 may be a group of companies, universities, individuals or other entities that desire to use data sets, machine learning algorithms or AI models of other members of consortium 630 or provide data sets, machine learning algorithms or AI models to other members of consortium 630. Consortium 630 may provide a legal, financial, and governance framework for the example system.

Data marketplace 632 (which may be an example of marketplace 504) may be responsible for member registration, asset registration and cataloging (e.g., what data sets, machine learning algorithms and AI models are available in the example system), trade agreements, payment clearance, auditing, governance, dispute resolution and third party tool orchestration.

Secure data exchange 634 (which may be an example of secure sandbox 502) may include an AI hub 636. AI hub 636 may be responsible for data ingestion, AI and machine learning, data warehousing, anonymization (for consortia whose members want their data sets anonymized), visualization, and distribution services. Secure data exchange 634 may also include a computer/container platform 638, storage 640, network 642 and data center 644 (or portions thereof). Computer/container platform 638 may be responsible for compute services and container management. Storage 640 may be responsible for storage and key management. Network 642 may be responsible for network fabric, network function virtualization and security services. Data center 644 may be responsible for data center services.

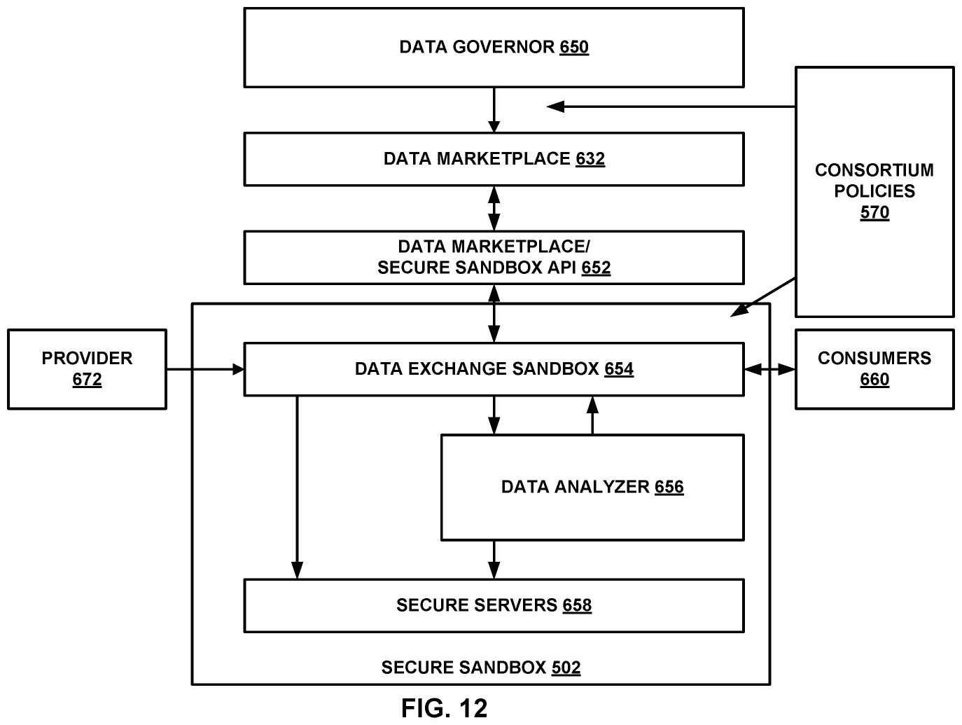

FIG. 12 is a conceptual diagram illustrating a control flow of an example system according to techniques of this disclosure. Data governor 650, such as an ExchangeWell™ forum from SIA ITC, may provide a data governance structure, such as tracking of qualified entities and sharing of data and algorithms. Data governor 650 may be subject to or restricted by consortium policies 570. Data marketplace 632 (which may be an example of marketplace 504) may receive data governance information from data governor 650. Data marketplace 632 may communicate with secure sandbox 502 through data marketplace/secure sandbox API 652. Data marketplace/secure sandbox API 652 may provide orchestration, security, chargeback and logging services to the example exchange system. In some examples, data marketplace/secure sandbox API 652 may reside in data marketplace 632. In other examples, data marketplace/secure sandbox API 652 may reside in secure sandbox 502. In further examples, data marketplace/secure sandbox API 652 may be external to both data marketplace 652 and secure sandbox 502. Provider 672 (such as data providers 524A-C or algorithm providers 526A-C) may provide data sets, machine learning algorithms or AI models to secure sandbox 502.

Secure sandbox 502 may also be restricted by consortium policies 570. Data exchange sandbox 654 may be accessible by consumers 660 (such as customers 108A-C) who may access data sets, machine learning algorithms and AI models with data exchange sandbox 654, e.g., placed there by data provider 672. Data analyzer 656 may interact with data exchange sandbox 654 to provide analytics reports on the data within data exchange sandbox 654, such as the data sets, machine learning algorithms and AI models and actions taken by data provider 672 and consumers 660. Secure servers 658 may provide a secure environment for data exchange sandbox 654 and data analyzer 656 to reside.

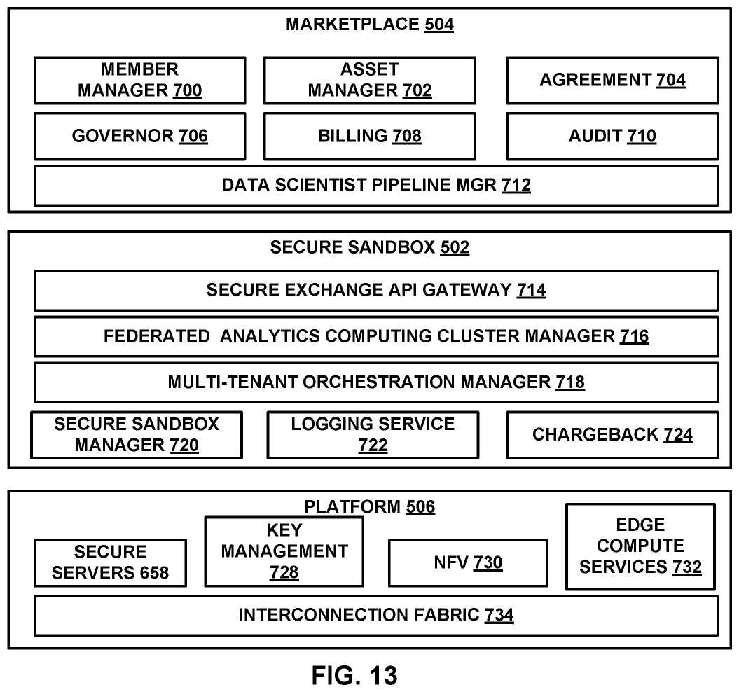

FIG. 13 is a block diagram illustrating an architecture of an example system in accordance with techniques of this disclosure. Marketplace 504 may include member manager 700, asset manager 702, agreement 704, governor 706, billing 708, audit 710 and data scientist pipeline manager 712. Member manager 700 may, for example, maintain a list of authorized providers, such as data provider 672, and authorized consumers, such as consumers 660. Marketplace 504 and/or secure sandbox 502 may utilize member manager 700 and consortium policies 570 to restrict access to authorized providers and authorized consumers.

Asset manager 702 may keep track of assets within AI exchange 500, such as data sets, machine learning algorithms and AI models. Asset manager 702 may be used to provide a catalog of assets to consumers 660.

Agreement 704 may contain legal contracts and other agreements involved with the consortium and/or AI exchange 500. Governor 706 may contain governance rules, such as consortium policies 570 and may optionally contain data governor 650. Governor 706 may contain algorithm(s) to enforce consortium policies 570. Billing 708 may include a billing system that may keep track of accounts payable and accounts receivable for data provider 672 and consumers 660. Billing 708 may provide periodic billing statements or billing statements upon user demand. Billing 708 may also track revenue generated or spent by a particular member organization of the consortium, or by the consortium as a whole.

Audit 710 may provide an audit function for AI exchange 500. Audit 710 may audit financial transactions, AI model transactions, or movement of items in and out of secure sandbox 502 or marketplace 504, for example. Data scientist pipeline manager 712 may manage experiment pipeline 531 and/or industrialize pipeline 533 discussed above.

Secure sandbox 502 may contain secure exchange API gateway 714, federated analytics computing cluster manager 716, multi-tenant orchestration manager 718, secure sandbox manager 720, logging service 722 and chargeback 724.

Secure exchange API gateway 714 may provide an API for data provider 672 and consumers 660 to access secure sandbox 502. Federated analytics computing cluster manager 716 may provide users with analytical insight into the computing clusters involved in secure sandbox 502 and/or AI exchange 500. For example, federated analytics computing cluster manager 716 may report on the total usage of all system computing cluster assets as a whole.

Multi-tenant orchestration manager 718 may operate to keep each member of the consortium or each user's data (such as data sets, machine learning algorithms and AI models) separate. In some examples, multi-tenant orchestration manager 718 may keep each user's data invisible to other users until otherwise authorized. Secure sandbox manager 720 may manage secure sandbox 502's resources. Logging service 722 may log accesses to secure sandbox 502 or to particular data sets, machine learning algorithms, or AI models. For example, logging service may log who made the access, when the access was made, what was accessed, etc. Chargeback 724 may operate to charge users of secure sandbox 502.

Platform 506 may include secure servers 658, key management service 728, network function virtualizer (NFV) 730, edge compute services 732 and interconnection fabric 734. Secure servers 726 may provide a secure execution environment for secure sandbox 502 and/or marketplace 504. Key management service 728 may manage encryption keys used to keep secure sandbox secure and encryption keys used to interact with model registry 508. For example, key management service 728 may issue keys to new users and may compare keys received during access requests to keys store locally. Network function virtualizer 730 may virtualize network node functions to create services associated with AI exchange 500. Edge compute services 732 may provide edge compute services for users of AI exchange 500. For example, edge compute services 732 may move data being used by a user of AI exchange 500 closer to the user so that AI exchange response time as experienced by that user may be reduced. Interconnection fabric 734 (such as IP/MPLS fabric 301) may provide interconnection between users, such as provider 672 and consumers 660, secure servers 658 (on which secure sandbox 502 may reside) and marketplace 504 (if it does not reside on secure servicers 658). Additional description of an example platform 506 providing key management and network function virtualization, for instance, is found in U.S. patent application Ser. No. 16/006,458, filed Jun. 12, 2018; and U.S. Provisional Patent Appl. No. 62/908,976, filed Oct. 1, 2019; which are incorporated by reference herein in their entireties.

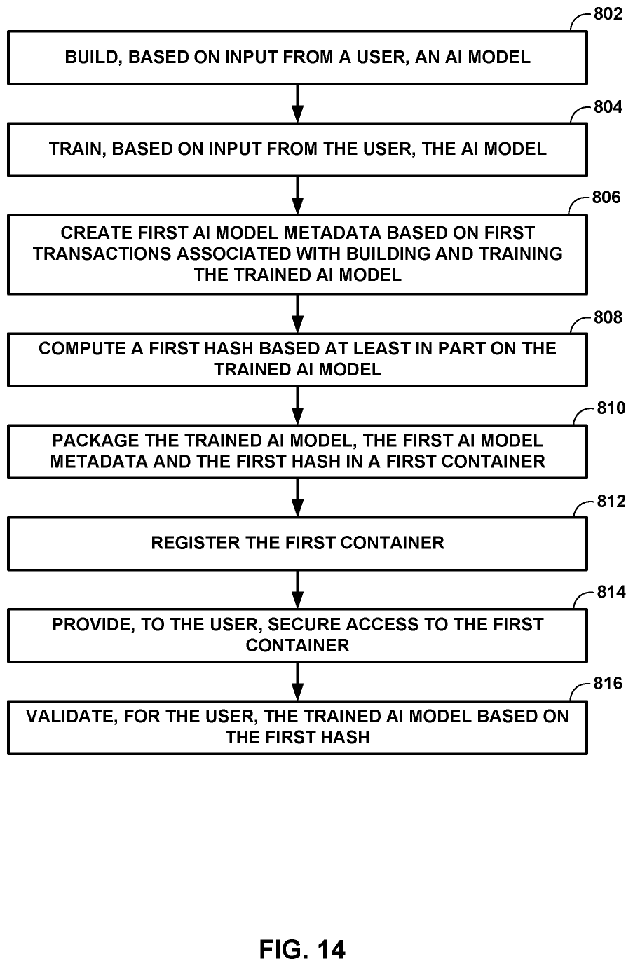

FIG. 14 is a flowchart illustrating example AI exchange techniques according to this disclosure. Secure sandbox 502 may build, based on input from a user, an AI model (802). For example, a user may utilize experiment pipeline 531 or industrialize pipeline 533 to provide input to secure sandbox 502 and secure sandbox 502 may build an AI model, for example, using a machine learning algorithm (e.g., machine learning algorithm 503A of FIG. 5) and at least one data set (e.g., data set 501A of FIG. 5). Secure sandbox 502 may train, based on input from the user, the AI model (804). For example, a user may utilize experiment pipeline 531 or industrialize pipeline 533 to provide input to secure sandbox 502 and secure sandbox 502 may train the AI model with another data set (e.g., data set 501B).

Secure sandbox 502 may create first AI model metadata based on first transactions associated with building and training the trained AI model (806). For example, secure sandbox 502 may monitor transactions involving an AI model and create AI model metadata based on those transactions. For example, secure sandbox 502 may create AI model attributes 752 (of FIG. 7) and/or AI model transaction data attributes 760 (of FIG. 7).

Secure sandbox 502 may compute a first hash based at least in part on the trained AI model (808). For example, secure sandbox 502 may compute model hash 764 based at least in part on the trained AI model.

Secure sandbox 502 may package the trained AI model, the first AI model metadata, and the first hash in a first container (810). For example, secure sandbox may serialize the trained AI Model and package serialized model objects file 750 (which may be a serialized version of the trained AI model), AI model attributes 752, model transaction data attributes 760, and model hash 764.

Model registry 508 may register the first container (812). For example, secure sandbox 502 may publish container 566 to model registry 508. Model registry 508 may store container 566 and/or may store AI model metadata relating to container 566, such as model attributes 514, training transactions 516, training data 518, and/or training infrastructure 520 in blockchain records 512.

Secure sandbox 502 may provide, to the user, secure access to the first container (814). For example, secure sandbox 502 may provide secure access to container 566 through data exchange sandbox 654 or through secure exchange API gateway 714.

Model registry 508 may validate, for the user, the trained AI model based on the first hash (816). For example, for example, model request validator 612 may receive requests to validate an AI model. Model request validator 612 may access ledger 624 (through, for example, blockchain adapter 614) and locate the hash (in some examples, located within a container) associated with the AI model, check the hash against the hash associated with the request and report the validation back to the user.

In some examples, secure sandbox 502 may determine whether the trained AI model is further trained after creating the first AI model metadata. For example, secure sandbox may monitor the AI models to determine whether a trained AI model is further trained. Secure sandbox 502 may create, based on the trained AI model being further trained, second AI model metadata, the second AI model metadata being based on the first transactions and second transactions associated with the further training of the trained AI model. Model registry 508 (or alternatively secure sandbox 502) may create a second hash through any known techniques based at least in part on the further trained AI model. Secure sandbox 502 may package the further trained AI model, the second AI model metadata and the second hash in a second container. Model registry 508 may register the second container.

In some examples, the first AI model metadata includes one or more of AI model attributes, AI model training transaction information, AI model training data usage information, or AI model training infrastructure information. In some examples, model registry 508 registers the first container in a blockchain-based registry.

In some examples, secure sandbox 502 may create a secure environment. Secure sandbox 502 may receive a machine learning algorithm from a first provider. Secure sandbox 502 may place the machine learning algorithm in the secure environment. Secure sandbox 502 may receive a data set from a second provider. Secure sandbox 502 may place the data set in the secure environment. Secure sandbox 502 may build a secure AI model in the secure environment based on the machine learning algorithm. Secure sandbox 502 may train the secure AI model in the secure environment based on the data set. Secure sandbox 502 may create secure AI model metadata based on transactions associated with the secure AI model, wherein the transactions comprise the building of the secure AI model and the training of the secure AI model and wherein the secure AI model metadata is indicative of the secure AI model's provenance.

In some examples, secure sandbox 502 may create the secure environment by restricting one or more of egress and ingress of data, egress and ingress of the trained AI model, data providers identities, model providers identities, or model changes.

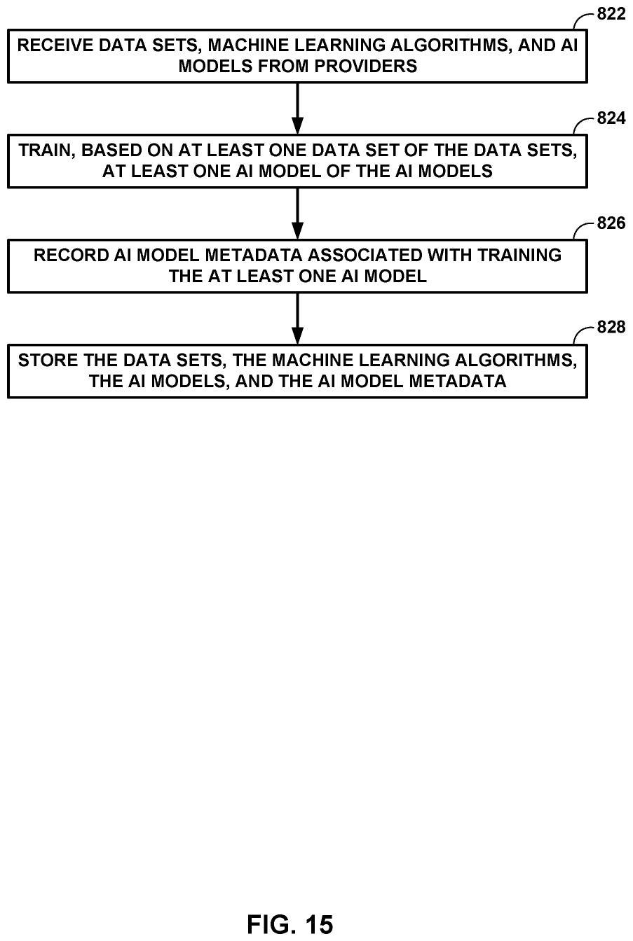

FIG. 15 is a flowchart illustrating example secure sandbox techniques according to this disclosure. Secure sandbox 502 may receive data sets, machine learning algorithms, and AI models from providers (822). For example, secure sandbox 502 may receive data sets 501A-501C from data providers 524A-524C. Secure sandbox 502 may receive machine learning algorithms 503A-503C from algorithm providers 526A-526C. Secure sandbox 502 may receive AI models from providers or from users (who, in some examples, may be considered providers) who may create the AI models, for example, in experiment pipeline 531 or in industrialize pipeline 533.

Secure sandbox 502 may train, based on at least one data set of the data sets, at least one AI model of the AI models (824). For example, secure sandbox 502 may, based on user input, train an AI model on at least one data set, such as data set 501B. Secure sandbox 502 may record AI model metadata associated with training the at least one AI model (826). For example, secure sandbox may monitor transactions associated with an AI model and record AI model parameters 752 and/or model transaction data attributes 760 or other metadata associated with the transactions. Secure sandbox 502 may store the data sets, the machine learning algorithms, the AI models, and the AI model metadata (828). For example, when computing system 13500 represents secure sandbox 502, computing system 13500 may store the data sets, the machine learning algorithms, the AI models, and the AI model metadata in storage device(s) 13508.

In some examples, secure sandbox 502 includes experiment pipeline 531 and industrialize pipeline 533, and the training and recording are performed by at least one of experiment pipeline 531 or industrialize pipeline 533. In some examples, secure sandbox 502 may serialize the AI models and package each serialized AI model into a separate container. In some examples, each separate container comprises a serialized AI model, associated AI model metadata and an associated hash.

In some examples, secure sandbox 502 may transmit at least one of AI model metadata or the separate containers to model registry 508. In some examples, secure sandbox 502 may receive from model registry 508 an attestation of an AI model's lineage.

By providing an AI exchange that manages AI model metadata in an integrated fashion with an experiment pipeline and an industrial pipeline, the AI exchange may keep track of AI model metadata associated with each transaction affecting an AI model within the AI exchange. The AI model and AI model metadata may be containerized for access and validation purposes. A model registry may provide validation services to the AI exchange. For example, the model registry may attest to an AI model's lineage and the AI model metadata associated therewith. The model registry and the AI exchange (or portions thereof) may be run by a third party, otherwise unaffiliated with a consortium using the AI exchange, thereby providing further assurances to members of the consortium that the data sets, machine learning algorithms and AI models within the AI exchange are what they purport to be. A single secure sandbox may be used by multiple marketplaces. Likewise, a single marketplace may use multiple secure sandboxes. Also, a single model registry may service multiple AI exchanges.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such as a processor or an integrated circuit device, such as an integrated circuit chip or chipset. Alternatively or additionally, if implemented in software or firmware, the techniques may be realized at least in part by a computer-readable data storage medium comprising instructions that, when executed, cause a processor to perform one or more of the methods described above. For example, the computer-readable data storage medium may store such instructions for execution by a processor.

A computer-readable medium may form part of a computer program product, which may include packaging materials. A computer-readable medium may comprise a computer data storage medium such as random access memory (RAM), read-only memory (ROM), non-volatile random access memory (NVRAM), electrically erasable programmable read-only memory (EEPROM), Flash memory, magnetic or optical data storage media, and the like. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, functionality described in this disclosure may be provided within software modules or hardware modules.

What is claimed is:

1. A system comprising:
memory; and
processing circuitry coupled to the memory, the processing circuitry being operable to:
build, based on input from a user, an artificial intelligence (AI) model;
train, based on input from the user, the AI model;
create first AI model metadata based on first transactions associated with building and training the trained AI model;
compute a first hash based at least in part on the trained AI model;
package the trained AI model, the first AI model metadata, and the first hash in a first container;
register the first container;
provide, to the user, secure access to the first container; and
validate, for the user, the trained AI model based on the first hash.

2. The system of claim 1, wherein the processing circuitry is further operable to:
determine whether the trained AI model is further trained after creating the first AI model metadata;
create, based on the trained AI model being further trained, second AI model metadata, the second AI model metadata being based on the first transactions and second transactions associated with the further training of the trained AI model;
create a second hash based at least in part on the further trained AI model; and
package the further trained AI model, the second AI model metadata and the second hash in a second container; and
register the second container.

3. The system of claim 1, wherein the first AI model metadata comprises one or more of AI model attributes, AI model training transaction information, AI model training data usage information, or AI model training infrastructure information.

4. The system of claim 1, wherein the processing circuitry is operable to register the first container in a blockchain-based registry.

5. The system of claim 1, wherein the processing circuitry is further operable to:
create a secure environment;
receive a machine learning algorithm from a first provider;
place the machine learning algorithm in the secure environment;
receive a data set from a second provider;
place the data set in the secure environment;
build a secure AI model in the secure environment based on the machine learning algorithm;
train the secure AI model in the secure environment based on the data set; and
create secure AI model metadata based on transactions associated with the secure AI model, wherein the transactions comprise the building of the secure AI model and the training of the secure AI model and wherein the secure AI model metadata is indicative of the secure AI model's provenance.

6. The system of claim 5, wherein the processing circuitry is further operable create the secure environment by restricting one or more of egress and ingress of data, egress and ingress of the trained AI model, data providers identities, model providers identities, or model changes.

7. A system comprising:
communication circuitry operable to receive data sets, machine learning algorithms and AI models from providers;
a secure sandbox coupled to the communication circuitry, the secure sandbox operable to train AI models and record AI model metadata associated with training AI models; and
memory operable to store the data sets, machine learning algorithms, AI modes and AI model metadata.

8. The system of claim 7, wherein the secure sandbox comprises an experiment pipeline and an industrialize pipeline, the experiment pipeline and the industrialize pipeline being operable to train the AI models and record the AI model metadata associated with training the AI models.

9. The system of claim 7, wherein the secure sandbox is further operable to serialize the AI models and package each serialized AI model into a separate container.

10. The system of claim 9, wherein each separate container comprises a serialized AI model, associated AI model metadata and an associated hash.

11. The system of claim 10, wherein the communication circuitry is further operable to transmit at least one of AI model metadata or the separate containers to a model registry.

12. The system of claim 11, wherein the communication circuitry is further operable to receive from the model registry an attestation of an AI model's lineage.

13. A method comprising:
building, by a system and based on input from a user, an AI model;
training, by the system and based on input from the user, the AI model;
creating, by the system, first AI model metadata based on first transactions associated with building and training the trained AI model;
computing, by the system, a first hash based at least in part on the trained AI model;
package the trained AI model, the first AI model metadata, and the first hash in a first container;
registering, by the system, the first container;
providing, by the system to the user, secure access to the first container; and
validating, by the system for the user, the trained AI model based on the first hash.

14. The method of claim 13, further comprising:
determining, by the system, whether the trained AI model is further trained after creating the first AI model metadata;
creating, by the system and based on the trained AI model being further trained, second AI model metadata, the second AI model metadata being based on the first transactions and second transactions associated with the further training of the trained AI model;
creating, by the system, a second hash based at least in part on the further trained AI model; and
packaging, by the system, the further trained AI model, the second AI model metadata and the second hash in a second container; and
registering, by the system, the second container.

15. The method of claim 13, wherein the first AI model metadata comprises one or more of AI model attributes, AI model training transaction information, AI model training data usage information, or AI model training infrastructure information.

16. The method of claim 13, wherein the registering the first container comprises registering the first container in a blockchain-based registry.

17. The method of claim 13, further comprising:
creating, by the system, a secure environment;
receiving, by the system, a machine learning algorithm from a first provider;
placing, by the system, the machine learning algorithm in the secure environment;
receiving, by the system, a data set from a second provider;
placing, by the system, the data set in the secure environment;
building, by the system, a secure AI model in the secure environment based on the machine learning algorithm;
training, by the system, the secure AI model in the secure environment based on the data set; and
creating, by the system, secure AI model metadata based on transactions associated with the secure AI model, wherein the transactions comprise the building of the secure AI model and the training of the secure AI model and wherein the secure AI model metadata is indicative of the secure AI model's provenance.

18. The system of claim 17, further comprising creating, by the system, the secure environment by restricting one or more of egress and ingress of data, egress and ingress of the trained AI model, data providers identities, model providers identities, or model changes.

19. A method:
receiving, by a system, data sets, machine learning algorithms, and AI models from providers;
training, by the system and based on at least one data set of the data sets, at least one AI model of the AI models;
recording, by the system, AI model metadata associated with training the at least one AI model; and
storing, by the system, the data sets, the machine learning algorithms, the AI models and the AI model metadata.

20. The method of claim 19, wherein the system comprises an experiment pipeline and an industrialize pipeline, and the training and recording are performed by at least one of the experiment pipeline or the industrialize pipeline.

21. The method of claim 19, further comprising:
serializing the AI models; and
packaging each serialized AI model into a separate container.

22. The method of claim 21, wherein each separate container comprises a serialized AI model, associated AI model metadata and an associated hash.

23. The method of claim 22, further comprising transmitting at least one of AI model metadata or the separate containers to a model registry.

24. The method of claim 23, further comprising receiving from the model registry an attestation of an AI model's lineage.
